(19) United States
(12) Patent Application Publication
(10) Pub. No.: US 2017/0249531 A1
(43) Pub. Date: Aug. 31, 2017

(54) METHOD OF AND SYSTEM FOR STORING TWO-DIMENSIONAL OBJECTS

(71) Applicant: YANDEX EUROPE AG, Luzern (CH)

(72) Inventor: Anton Vasilyevich KORZUNOV, Podolsk, Moscow region (RU)

(73) Assignee: Yandex Erope AG, Luzern (CH)

(21) Appl. No.: 15/505,792

(22) PCT Filed: Sep. 17, 2014
(86) PCT No.: PCT/IB15/57163

§ 371 Date: Feb. 22, 2017

(30) Foreign Application Priority Data
May 25, 2015 (RU) 2015119413

(51) Int. Cl. G06K 9/48; G06K 9/60; G06K 15/02; G06T 3/20; G06T 3/40; G06T 3/60; G06T 9/20; G06T 13/20; G06T 13/80; G06T 15/04; G06T 15/40; G06T 15/60; G09G 1/08; G09G 1/14; G06K 9/54

(52) U.S. Cl. CPC G06K 9/48; G06K 9/54; G06K 9/60; G06K 15/02; G06T 3/20; G06T 3/40; G06T 3/60; G06T 9/20; G06T 13/205; G06T 13/80; G06T 15/04; G06T 15/40; G06T 15/60; G09G 1/08; G09G 1/14

(57) ABSTRACT

A system for and method of storing two two-dimensional objects on an information storage medium, the method comprising: acquiring a first two-dimensional object and a second, a first perimeter of the first two-dimensional object comprising a first perimeter portion and a second perimeter portion, and the second two-dimensional object comprising the second perimeter portion and a third perimeter portion; storing, on the information storage medium, the first perimeter as storing the first and the second perimeter portions; storing, on the information storage medium, the second perimeter as storing the third perimeter portion and storing a reference to the second perimeter portion.

### CROSS-REFERENCE

The present application claims priority to Russian Patent Application No 2015119413, filed May 25, 2015, entitled “METHOD OF AND SYSTEM FOR STORING TWO-DIMENSIONAL OBJECTS” the entirety of which is incorporated herein.

### FIELD OF THE TECHNOLOGY

The present technology relates to method of and system for storing two two-dimensional objects.

### BACKGROUND

In computer technologies, there is a need for storing two-dimensional graphical objects which can be further displayed on a display screen of a computer device. These two-dimensional objects could be any graphical objects, such as maps or other images. These images can originate from multiple sources, such as be a scanned image, downloaded images from a remote server and the like.

In computer graphics, two basic forms of representation are used to define an image: a raster representation and a vector representation. Naturally, in certain circumstances there may be a need to translate a given image from one format of representation to another. For instance, the US patent bearing a patent number U.S. Pat. No. 6,639,593 B1 and entitled “Converting bitmap objects to polygons” explains in its background section, that “it is sometimes convenient or necessary to obtain a vector representation of one or more regions in a bitmap, for example to manipulate the shape of a bitmap region, to scale a bitmap region, to trap an object, or to clip a vector object against a bitmap mask. One method for obtaining a vector representation is to trace around the boundary of the bitmap object from pixel to pixel to create a closed contour, or polygon, corresponding to the bitmap object.”

Typically, when storing several two-dimensional objects, the two-dimensional objects are saved independently therebetween, which may require substantial memory resources of computer-readable storage mediums.

Further, some two-dimensional objects can have hierarchy. For example, a map object representative of the State of California is a part of the USA, and the USA is a part of North America. In many cases, there is a need to store, along with borders of two-dimensional objects, their mutual hierarchy information.

### SUMMARY

It is thus an object of the present technology to ameliorate at least some of the inconveniences present in the prior art.

In one aspect, implementations of the present technology provide a method of storing at least two two-dimensional objects on an information storage medium, the method executed on a computing device, the computing device having access to the information storage medium, the method comprising: (1) acquiring a first two-dimensional object to be stored on the information storage medium, a first perimeter of the first two-dimensional object comprising a first perimeter portion and a second perimeter portion; (2) storing, on the information storage medium, the first perimeter as: (i) storing the first perimeter portion as a first line, connecting two extreme points of the first perimeter portion, wherein a first extreme point of the first perimeter portion is stored as a start extreme point of the first perimeter portion, and a second extreme point of the first perimeter portion is stored as an end extreme point the first perimeter portion, (ii) storing the second perimeter portion of the first perimeter as a second line, connecting two extreme points of the second perimeter portion, wherein a first extreme point of the second perimeter portion is stored as a start extreme point of the second perimeter portion, and a second extreme point of the second perimeter portion is stored as an end extreme point of the second perimeter portion, the end extreme point the first perimeter portion being the start extreme point of the second perimeter portion; and (3) acquiring a second two-dimensional object to be stored on the information storage medium, a second perimeter of the second two-dimensional object comprising the second perimeter portion and a third perimeter portion, the second perimeter portion being a first common perimeter portion of the first two-dimensional object and of the second two-dimensional object; (4) verifying logical hierarchy of the second two-dimensional object and the first two-dimensional object, and (i) responsive to the second two-dimensional object being encompassed by the first two-dimensional object, storing, on the information storage medium, the second perimeter as: storing the third perimeter portion as a third line, connecting two extreme points of the third perimeter portion, wherein a first extreme point of the third perimeter portion is stored as a start extreme point of the third perimeter portion, and wherein a second extreme point of the third perimeter portion is stored as an end extreme point of the third perimeter portion, and storing a reference to the second perimeter portion of the first perimeter; (ii) responsive to the second two-dimensional object and the first two-dimensional object being neighboring two-dimensional objects, storing, on the information storage medium, the second perimeter as: storing the third perimeter portion as a third line, connecting two extreme points of the third perimeter portion, wherein a first extreme point of the third perimeter portion is stored as a start extreme point of the third perimeter portion, and wherein a second extreme point of the third perimeter portion is stored as an end extreme point of the third perimeter portion, and storing a reference to the second perimeter portion of the first perimeter, the reference including an instruction to interpret the start extreme point of the second perimeter portion of the first perimeter as an end extreme point of the second perimeter portion of the second perimeter, and to interpret the end extreme point of the second perimeter portion of the first perimeter as a start extreme point of the second perimeter portion of the second perimeter.

In some implementations, (1) extreme points of a respective perimeter are connected by respective lines in a first selected rotational direction, starting from an extreme point and finishing by the same extreme point, and (2) the first rotational direction is selected from: (a) a clockwise direction and (b) a counter-clockwise direction.

In some implementations, at least one of (a) the first two-dimensional object and (b) the second two-dimensional object is a polygonal object.

In some implementations, each of the first two-dimensional object and the second two-dimensional object is a part of a plurality of two-dimensional objects, and the plurality of two two-dimensional objects is a plurality of map objects.

In some implementations storing, on the information storage medium, at least one, selected from: the first perimeter portion, the second perimeter portion, and the third perimeter portion, is storing in an at least one database.

In yet another aspect, implementations of the present technology provide a server. The server comprises: an information storage medium; a processor operationally connected to the information storage medium, the processor configured to store objects, on the information storage medium, the processor being further configured to: (1) acquire a first two-dimensional object to be stored on the information storage medium, a first perimeter of the first two-dimensional object comprising a first perimeter portion and a second perimeter portion; (2) store, on the information storage medium, the first perimeter by: (i) storing the first perimeter portion as a first line, connecting two extreme points of the first perimeter portion, wherein a first extreme point of the first perimeter portion is stored as a start extreme point of the first perimeter portion, and a second extreme point of the first perimeter portion is stored as an end extreme point the first perimeter portion, (ii) storing the second perimeter portion of the first perimeter as a second line, connecting two extreme points of the second perimeter portion, wherein a first extreme point of the second perimeter portion is stored as a start extreme point of the second perimeter portion, and a second extreme point of the second perimeter portion is stored as an end extreme point of the second perimeter portion, the end extreme point the first perimeter portion being the start extreme point of the second perimeter portion; and (3) acquire a second two-dimensional object to be stored on the information storage medium, a second perimeter of the second two-dimensional object comprising the second perimeter portion and a third perimeter portion, the second perimeter portion being a first common perimeter portion of the first two-dimensional object and of the second two-dimensional object; (4) verify logical hierarchy of the second two-dimensional object and the first two-dimensional object, and (i) responsive to the second two-dimensional object being encompassed by the first two-dimensional object, store, on the information storage medium, the second perimeter by: storing the third perimeter portion as a third line, connecting two extreme points of the third perimeter portion, wherein a first extreme point of the third perimeter portion is stored as a start extreme point of the third perimeter portion, and wherein a second extreme point of the third perimeter portion is stored as an end extreme point of the third perimeter portion, and storing a reference to the second perimeter portion of the first perimeter; (ii) responsive to the second two-dimensional object and the first two-dimensional object being neighboring two-dimensional objects, store, on the information storage medium, the second perimeter by: storing the third perimeter portion as a third line, connecting two extreme points of the third perimeter portion, wherein a first extreme point of the third perimeter portion is stored as a start extreme point of the third perimeter portion, and wherein a second extreme point of the third perimeter portion is stored as an end extreme point of the third perimeter portion, and by storing a reference to the second perimeter portion of the first perimeter, the reference including an instruction to interpret the start extreme point of the second perimeter portion of the first perimeter as an end extreme point of the second perimeter portion of the second perimeter, and to interpret the end extreme point of the second perimeter portion of the first perimeter as a start extreme point of the second perimeter portion of the second perimeter.

In some implementations of the server, (1) extreme points of a respective perimeter are connected by respective lines in a first selected rotational direction, starting from an extreme point and finishing by the same extreme point, and (2) the first rotational direction is selected from: (a) a clockwise direction and (b) a counter-clockwise direction.

In some implementations of the server, at least one of (a) the first two-dimensional object and (b) the second two-dimensional object is a polygonal object.

In some implementations of the server, each of the first two-dimensional object and the second two-dimensional object is a part of a plurality of two-dimensional objects, and the plurality of two two-dimensional objects is a plurality of map objects.

In some implementations of the server storing, on the information storage medium, at least one, selected from: the first perimeter portion, the second perimeter portion, and the third perimeter portion, is storing in an at least one database.

In yet another aspect, implementations of the present technology provide a method of restoring logical hierarchy of at least two two-dimensional objects, a first two-dimensional object having a first perimeter, a second two-dimensional object having a second perimeter, the first perimeter and the second perimeter comprising perimeter portions, each perimeter portion being a line connecting two extreme points of a respective perimeter portion, extreme points in the first perimeter being connected by respective lines in a first selected rotational direction, extreme points of the second perimeter being connected by respective lines in the first selected rotational direction, the method executed on a computing device. The method comprises: (1) acquiring the first two-dimensional object and the second two-dimensional object; (2) determining if the first two-dimensional object and the second two-dimensional object have a first common perimeter portion; (3) responsive to determining that the first two-dimensional object and the second two-dimensional object having the first common perimeter portion, determining if the first common perimeter portion, in respect of both the first two-dimensional object and the second two-dimensional object, is connected in a same direction of connection; (4) in response to the sequence of two extreme points of the first common perimeter portion, in respect of both the first two-dimensional object and the second two-dimensional object, being connected in the same direction of connection, (i) determining sizes of the first two-dimensional object and the second two-dimensional object, and (ii) determining that a smaller two-dimensional object, selected from: the first two-dimensional object and the second two-dimensional object, is encompassed by a larger two-dimensional object, selected from other one of: the first two-dimensional object and the second two-dimensional object; and (5) in response to the sequence of two extreme points of the first common perimeter portion, in respect of both the first two-dimensional object and the second two-dimensional object, being connected in opposing directions of connection, determining, that the first two-dimensional object and the second two-dimensional object are neighbors.

In some implementations, wherein the second two-dimensional object is encompassed by the first two-dimensional object, the method further comprises acquiring a third two-dimensional object, the third two-dimensional object having a second common perimeter portion with the second two-dimensional object, the third two-dimensional object having no common perimeter portion with the first two-dimensional object, the method further comprises: (1) determining if the second common perimeter portion, in respect of both the third two-dimensional object and the second two-dimensional object, is connected in a same direction of connection, and (2) in response to the sequence of two extreme points of the second common perimeter portion, in respect of both the third two-dimensional object and the second two-dimensional object, being connected in opposing directions of connection: (i) determining that the third two-dimensional object and the second two-dimensional object are neighbors, and (ii) determining that the third two-dimensional object is encompassed by the first two-dimensional object.

In some implementations, wherein the first two-dimensional object and the second two-dimensional object are a part of a plurality of two-dimensional objects, the method further comprises determining logical hierarchy of at least two two-dimensional objects from the plurality of two-dimensional objects, wherein a rank of a corresponding two-dimensional object is inversely related to a number of other two-dimensional objects encompassing said corresponding two-dimensional object.

In some implementations, rotational direction is selected from: (a) a clockwise direction and (b) a counter clockwise direction.

In some implementations, at least one of (a) the first two-dimensional object and (b) the second two-dimensional object is a polygonal object.

In some implementations, the first two-dimensional object and the second two-dimensional object are the part of a plurality of two-dimensional objects, and the plurality of two two-dimensional objects is a plurality of map objects.

In some implementations, prior to the acquiring the first perimeter, the second perimeter, and determining if the first two-dimensional object and the second two-dimensional object have the first common perimeter portion, the method further comprises: (1) acquiring the first two-dimensional object to be stored on the information storage medium, the first perimeter of the first two-dimensional object comprising a first perimeter portion and a second perimeter portion; (2) storing, on the information storage medium, the first perimeter as: (i) storing the first perimeter portion as a first line, connecting two extreme points of the first perimeter portion, wherein a first extreme point of the first perimeter portion is stored as a start extreme point of the first perimeter portion, and a second extreme point of the first perimeter portion is stored as an end extreme point the first perimeter portion, (ii) storing the second perimeter portion of the first perimeter as a second line, connecting two extreme points of the second perimeter portion, wherein a first extreme point of the second perimeter portion is stored as a start extreme point of the second perimeter portion, and a second extreme point of the second perimeter portion is stored as an end extreme point of the second perimeter portion, the end extreme point the first perimeter portion being the start extreme point of the second perimeter portion; and (3) acquiring the second two-dimensional object to be stored on the information storage medium, the second perimeter of the second two-dimensional object comprising the second perimeter portion and a third perimeter portion, the second perimeter portion being the first common perimeter portion of the first two-dimensional object and of the second two-dimensional object; (4) verifying logical hierarchy of the second two-dimensional object and the first two-dimensional object, and (i) responsive to the second two-dimensional object being encompassed by the first two-dimensional object, storing, on the information storage medium, the second perimeter as: storing the third perimeter portion as a third line, connecting two extreme points of the third perimeter portion, wherein a first extreme point of the third perimeter portion is stored as a start extreme point of the third perimeter portion, and wherein a second extreme point of the third perimeter portion is stored as an end extreme point of the third perimeter portion, and storing a reference to the second perimeter portion of the first perimeter; (ii) responsive to the second two-dimensional object and the first two-dimensional object being neighboring two-dimensional objects, storing, on the information storage medium, the second perimeter as: storing the third perimeter portion as a third line, connecting two extreme points of the third perimeter portion, wherein a first extreme point of the third perimeter portion is stored as a start extreme point of the third perimeter portion, and wherein a second extreme point of the third perimeter portion is stored as an end extreme point of the third perimeter portion, and storing a reference to the second perimeter portion of the first perimeter, the reference including an instruction to interpret the start extreme point of the second perimeter portion of the first perimeter as an end extreme point of the second perimeter portion of the second perimeter, and to interpret the end extreme point of the second perimeter portion of the first perimeter as a start extreme point of the second perimeter portion of the second perimeter.

In yet another aspect, implementations of the present technology provide a server. The server comprises: an information storage medium; a processor operationally connected to the information storage medium, the processor configured to store objects, on the information storage medium, the processor being further configured to: (1) acquire the first two-dimensional object and the second two-dimensional object; (2) determine if the first two-dimensional object and the second two-dimensional object have a first common perimeter portion; (3) responsive to determining that the first two-dimensional object and the second two-dimensional object having the first common perimeter portion, determine if the first common perimeter portion, in respect of both the first two-dimensional object and the second two-dimensional object, is connected in a same direction of connection; (4) in response to the sequence of two extreme points of the first common perimeter portion, in respect of both the first two-dimensional object and the second two-dimensional object, being connected in the same direction of connection, (i) determine sizes of the first two-dimensional object and the second two-dimensional object, and (ii) determine that a smaller two-dimensional object, selected from: the first two-dimensional object and the second two-dimensional object, is encompassed by a larger two-dimensional object, selected from other one of: the first two-dimensional object and the second two-dimensional object; and (5) in response to the sequence of two extreme points of the first common perimeter portion, in respect of both the first two-dimensional object and the second two-dimensional object, being connected in opposing directions of connection, determine, that the first two-dimensional object and the second two-dimensional object are neighbors.

In some embodiments of the server, wherein the second two-dimensional object is encompassed by the first two-dimensional object, the processor being further configured to acquire a third two-dimensional object, the third two-dimensional object having a second common perimeter portion with the second two-dimensional object, the third two-dimensional object having no common perimeter portion with the first two-dimensional object, the processor being further configured to: (1) determine if the second common perimeter portion, in respect of both the third two-dimensional object and the second two-dimensional object, is connected in a same direction of connection, and (2) in response to the sequence of two extreme points of the second common perimeter portion, in respect of both the third two-dimensional object and the second two-dimensional object, being connected in opposing directions of connection: (i) determine that the third two-dimensional object and the second two-dimensional object are neighbors, and (ii) determine that the third two-dimensional object is encompassed by the first two-dimensional object.

In some embodiments of the server, the processor being further configured to determine logical hierarchy of at least two two-dimensional objects, being a part of a plurality of two-dimensional objects, wherein a rank of a corresponding two-dimensional object is inversely related to a number of other two-dimensional objects encompassing said corresponding two-dimensional object.

In some embodiments of the server, rotational direction is selected from: (a) a clockwise direction and (b) a counter clockwise direction.

In some embodiments of the server, at least one of (a) the first two-dimensional object and (b) the second two-dimensional object is a polygonal object.

In some embodiments of the server, the first two-dimensional object and the second two-dimensional object are a part of a plurality of two-dimensional objects, and the plurality of two two-dimensional objects is a plurality of map objects.

In some embodiments of the server, the processor being further configured to: (1) acquire the first two-dimensional object to be stored on the information storage medium, a first perimeter of the first two-dimensional object comprising a first perimeter portion and a second perimeter portion; (2) store, on the information storage medium, the first perimeter by: (i) storing the first perimeter portion as a first line, connecting two extreme points of the first perimeter portion, wherein a first extreme point of the first perimeter portion is stored as a start extreme point of the first perimeter portion, and a second extreme point of the first perimeter portion is stored as an end extreme point the first perimeter portion, (ii) storing the second perimeter portion of the first perimeter as a second line, connecting two extreme points of the second perimeter portion, wherein a first extreme point of the second perimeter portion is stored as a start extreme point of the second perimeter portion, and a second extreme point of the second perimeter portion is stored as an end extreme point of the second perimeter portion, the end extreme point the first perimeter portion being the start extreme point of the second perimeter portion; and (3) acquire the second two-dimensional object to be stored on the information storage medium, the second perimeter of the second two-dimensional object comprising the second perimeter portion and a third perimeter portion, the second perimeter portion being the first common perimeter portion of the first two-dimensional object and of the second two-dimensional object; (4) verify logical hierarchy of the second two-dimensional object and the first two-dimensional object, and (i) responsive to the second two-dimensional object being encompassed by the first two-dimensional object, store, on the information storage medium, the second perimeter by: storing the third perimeter portion as a third line, connecting two extreme points of the third perimeter portion, wherein a first extreme point of the third perimeter portion is stored as a start extreme point of the third perimeter portion, and wherein a second extreme point of the third perimeter portion is stored as an end extreme point of the third perimeter portion, and storing a reference to the second perimeter portion of the first perimeter; (ii) responsive to the second two-dimensional object and the first two-dimensional object being neighboring two-dimensional objects, store, on the information storage medium, the second perimeter by: storing the third perimeter portion as a third line, connecting two extreme points of the third perimeter portion, wherein a first extreme point of the third perimeter portion is stored as a start extreme point of the third perimeter portion, and wherein a second extreme point of the third perimeter portion is stored as an end extreme point of the third perimeter portion, and storing a reference to the second perimeter portion of the first perimeter, the reference including an instruction to interpret the start extreme point of the second perimeter portion of the first perimeter as an end extreme point of the second perimeter portion of the second perimeter, and to interpret the end extreme point of the second perimeter portion of the first perimeter as a start extreme point of the second perimeter portion of the second perimeter.

In the context of the present specification, unless specifically provided otherwise, a “server” is a computer program that is running on appropriate hardware and is capable of receiving requests (e.g. from client devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, unless specifically provided otherwise, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, unless specifically provided otherwise, the expression “information” includes information of any nature or kind whatsoever, comprising information capable of being stored in a database. Thus information includes, but is not limited to audiovisual works (photos, movies, sound records, presentations etc.), data (map data, location data, numerical data, etc.), text (opinions, comments, questions, messages, etc.), documents, spreadsheets, etc.

In the context of the present specification, unless specifically provided otherwise, the expression “component” is meant to include software (appropriate to a particular hardware context) that is both necessary and sufficient to achieve the specific function(s) being referenced.

In the context of the present specification, unless specifically provided otherwise, the expression “information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, unless specifically provided otherwise, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

In the context of the present specification, unless specifically provided otherwise, the expression “two-dimensional object” is intended to mean a plane figure, displayed on a computer screen, the plane figure that is bounded by a finite chain of lines closing in a loop to form a closed circuit.

In the context of the present specification, unless specifically provided otherwise, the expression “polygonal object” is intended to two-dimensional object, displayed on a computer screen, the polygonal object that is bounded by a finite chain of straight lines closing in a loop to form a closed circuit.

In the context of the present specification, unless specifically provided otherwise, the word “perimeter” means a path that surrounds a two-dimensional object. Perimeter can comprise perimeter portions, which perimeter portions can be stored as lines, connecting two extreme points of respective perimeter portion.

In the context of the present specification, unless specifically provided otherwise, the expression “rotational direction” is intended to mean a sequence of connection of consecutive extreme points, so that the end extreme point of one perimeter portion is the start extreme point of the next perimeter portion of the same perimeter. Rotational direction can be either a clockwise direction, or a counter-clockwise direction.

In the context of the present specification, unless specifically provided otherwise, the expression “direction of connection” is intended to mean direction of connection of two extreme points of the same common perimeter portion with regard two two-dimensional objects, having that common perimeter portion. For example, a line connecting a first extreme point and a second extreme point of the same common perimeter portion can be connected in any one of two opposing directions of connection: (1) “the first extreme point—the second extreme point”, such that the first extreme point is the start extreme point, and the second extreme point is the end extreme point; and (2) “the second extreme point—the first extreme point”, such that the second extreme point is the start extreme point, and the first extreme point is the end extreme point.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a schematic diagram of a system implemented in accordance with an embodiment of the present technology.

FIG. 2 depicts a non-limiting example of a first two-dimensional object, being polygonal object, wherein extreme points of the perimeter of the first two-dimensional object are connected by respective lines in a first selected rotational direction.

FIG. 3 depicts a non-limiting example of two two-dimensional objects, the first two-dimensional object encompassing the second two-dimensional object, both two-dimensional objects being polygonal objects, wherein extreme points of respective perimeters are connected by respective lines in the first selected rotational direction.

FIG. 4 depicts a non-limiting example of two two-dimensional objects, the first two-dimensional object and the second two-dimensional object being neighbouring objects, both two-dimensional objects being polygonal objects, wherein extreme points of respective perimeters are connected by respective lines in the first selected rotational direction.

FIG. 5 depicts a non-limiting example of two two-dimensional objects, the first two-dimensional object encompassing the second two-dimensional object, both two-dimensional objects being non-polygonal objects.

FIG. 6 depicts a non-limiting example of alternative implementation of the present technology, wherein extreme points of respective perimeters are connected by respective lines in a second selected rotational direction.

FIG. 7 depicts a computer-implemented method of storing at least two two-dimensional objects on an information storage medium, the method being implemented in accordance with non-limiting embodiments of the present technology and being executable on the server of the system of FIG. 1.

FIG. 8 depicts a block-diagram of a computer-implemented method 800 of restoring of logical hierarchy of at least two two-dimensional objects, the method being implemented in accordance with non-limiting embodiments of the present technology.

FIG. 9 depicts a non-limiting example of three two-dimensional objects, the first two-dimensional object encompassing the second two-dimensional object, and the third two-dimensional object, both two-dimensional objects being polygonal objects, wherein extreme points of respective perimeters are connected by respective lines in the first selected rotational direction

FIG. 10 depicts a variation 1000 of the computer-implemented method 800, the variation 1000 of the method 800 being implemented in accordance with non-limiting embodiments of the present technology.

FIG. 11 depicts a first two-dimensional object North America on the map of North America (Mainland).

FIG. 12 depicts a first two-dimensional object North America and the second two-dimensional object continental part of Canada on the map of North America (Mainland).

FIG. 13 depicts a first two-dimensional object North America, the second two-dimensional object continental part of Canada, the third two-dimensional object province of Quebec in Canada, and the fourth two-dimensional object province of Ontario in Canada, on the map of North America (Mainland).

### DETAILED DESCRIPTION

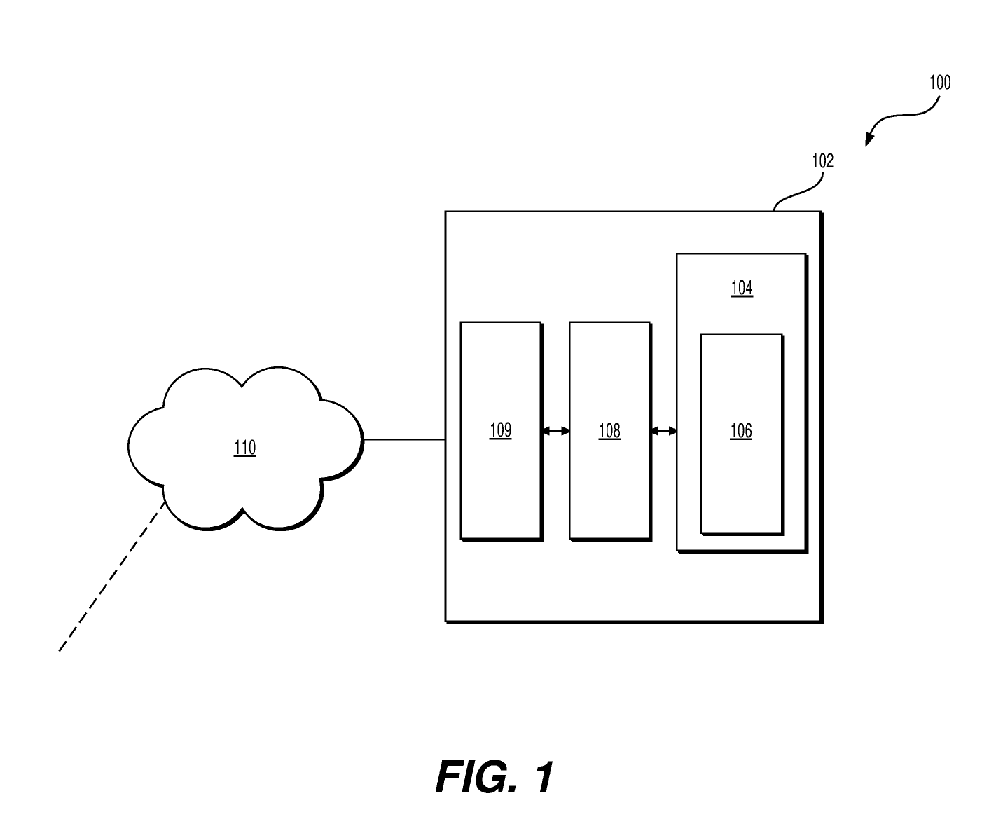

Referring to FIG. 1, there is shown a diagram of a system 100, the system 100 being suitable for implementing non-limiting embodiments of the present technology. It is to be expressly understood that the system 100 is depicted as merely as an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 100 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. In addition it is to be understood that the system 100 may provide in certain instances simple implementations of the present technology, and that where such is the case they have been presented in this manner as an aid to understanding. As persons skilled in the art would understand, various implementations of the present technology may be of a greater complexity.

System 100 includes a server 102. The server 102 may be implemented as a conventional computer server. In an example of an embodiment of the present technology, the server 102 may be implemented as a Dell™ PowerEdge™ Server running the Microsoft™ Windows Server™ operating system. Needless to say, the server 102 may be implemented in any other suitable hardware and/or software and/or firmware or a combination thereof. In the depicted non-limiting embodiment of present technology, the server 102 is a single server. In alternative non-limiting embodiments of the present technology, the functionality of the server 102 may be distributed and may be implemented via multiple servers.

In some implementations of the present technology, the server 102 can be under control and/or management of a map service provider, for example, provider of Maps.Yandex™. In alternative implementations the server 102 can access the map service provided by a third-party provider.

The server 102 includes an information storage medium 104 that may be used by the server 102. Generally, the information storage medium 104 may be implemented as a medium of any nature and kind whatsoever, including RAM, ROM, disks (CD-ROMs, DVDs, floppy disks, hard drivers, etc.), USB keys, solid state-drives, tape drives, etc. and also the combinations thereof.

The implementations of the server 102 are well known in the art. So, suffice it to state, that the server 102 comprises inter alia a network communication interface 109 (such as a modem, a network card and the like) (not depicted) for two-way communication over the communication network 110; and a processor 108 coupled to the network communication interface 109 and the information storage medium 104, the processor 108 being configured to execute various routines, including those described herein below. To that end the processor 108 may have access to computer readable instructions stored on the information storage medium 104, which instructions, when executed, cause the processor 108 to execute the various routines described herein.

In some non-limiting embodiments of the present technology, the communication network 110 can be implemented as the Internet. In other embodiments of the present technology, the communication network 110 can be implemented differently, such as any wide-area communication network, local-area communication network, a private communication network and so on.

The information storage medium 104 is configured to store data, including computer-readable instructions and other data, including map data. In some implementations of the present technology, the information storage medium 104 can store at least part of the data in a database 106.

The information storage medium 104 can store computer-readable instructions that manage control, updates, populating and modifications of the database 106. More specifically, computer-readable instructions stored on the information storage medium 104 allow the server 102 to receive (to update) information in respect of two-dimensional objects via the communication network 110, to store information in respect of the two-dimensional objects, including the information in respect of their respective perimeters in the database 106,

Map data stored on the information storage medium 104 (and, more specifically, in the database 106) can comprise two-dimensional objects of any kind. As a non-limiting example, a two-dimensional object can be a map object to be displayed on an electronic device associated with a user (both not depicted). As another non-limiting example, a two-dimensional object can be a picture or any other graphical object to be displayed on an electronic device associated with a user (both not depicted).

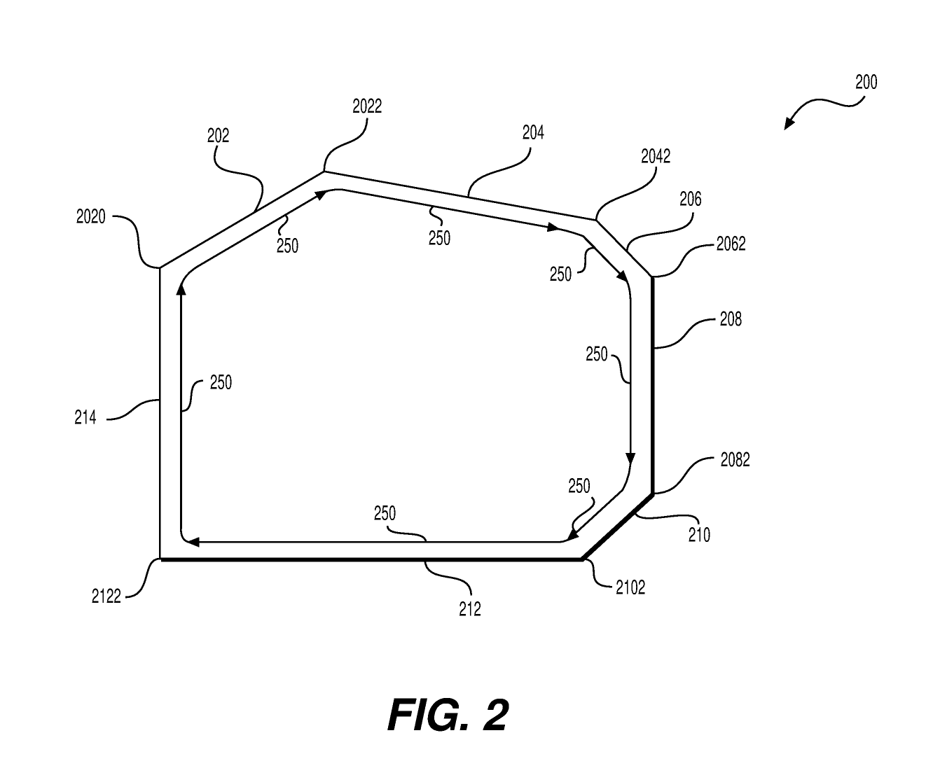

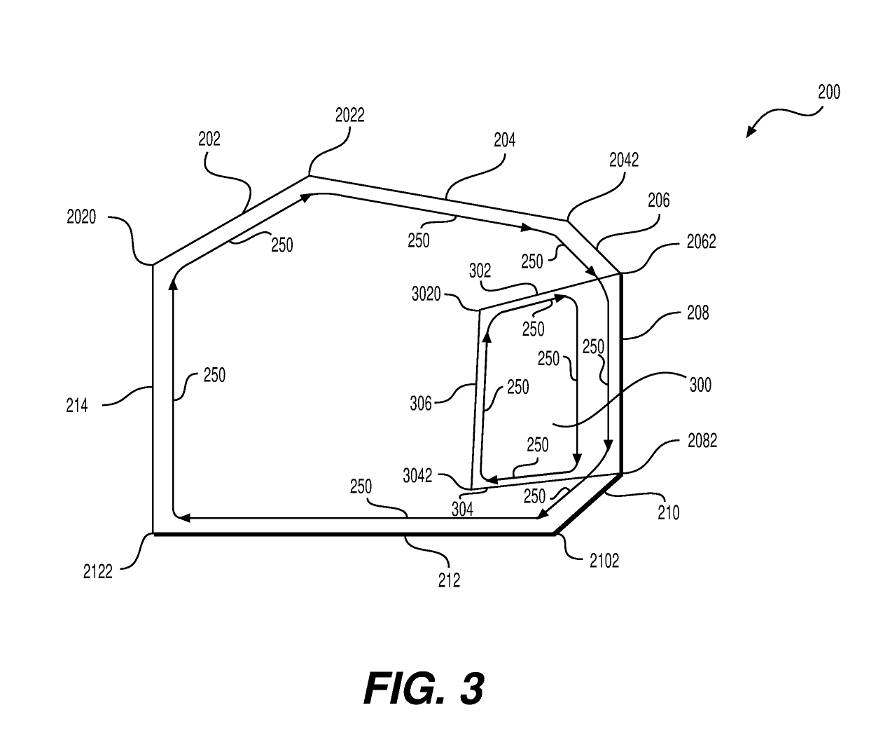

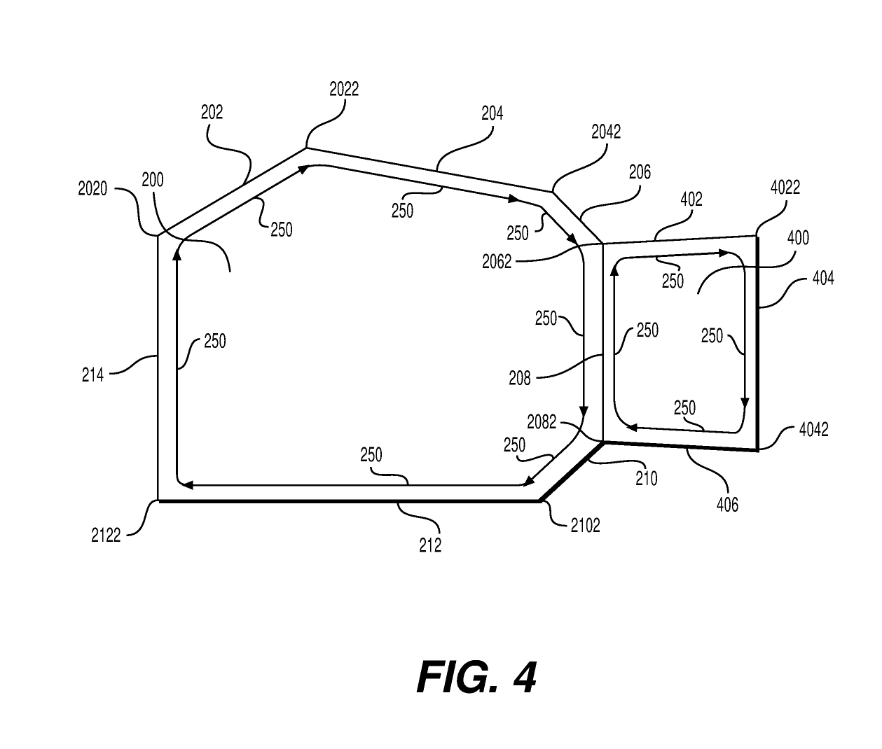

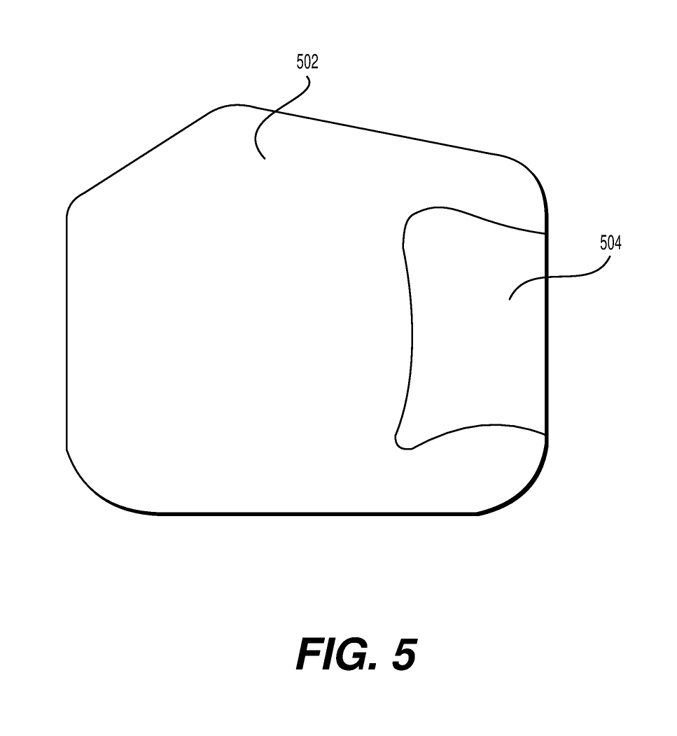

In some implementations of the present technology, two-dimensional objects can be polygonal objects, as depicted in FIG. 2, FIG. 3 and FIG. 4. In alternative implementations of the present technology, two-dimensional objects can be non-polygonal objects, as depicted in FIG. 5. FIG. 5 depicts a non-limiting example of two two-dimensional objects, the first two-dimensional object 502 encompassing the second two-dimensional object 504, both two-dimensional objects 502 and 504 being non-polygonal objects. In another alternative implementations of the present technology, some two-dimensional objects can be non-polygonal objects, and other two-dimensional objects can be polygonal objects (not depicted).

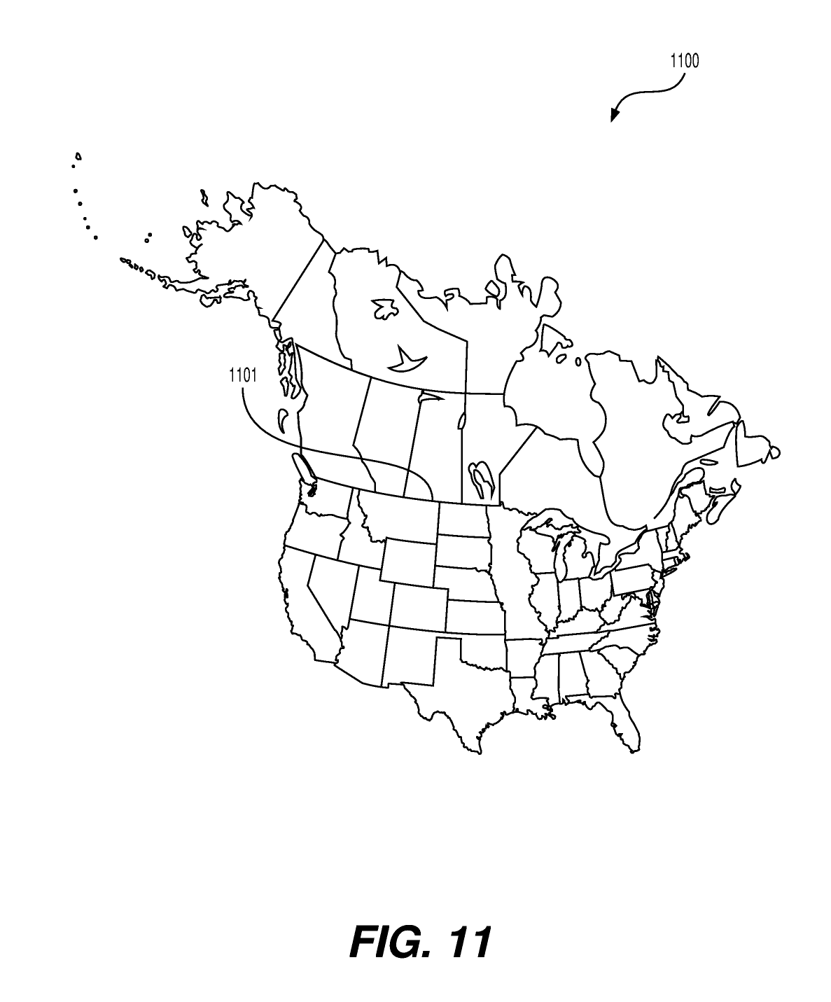

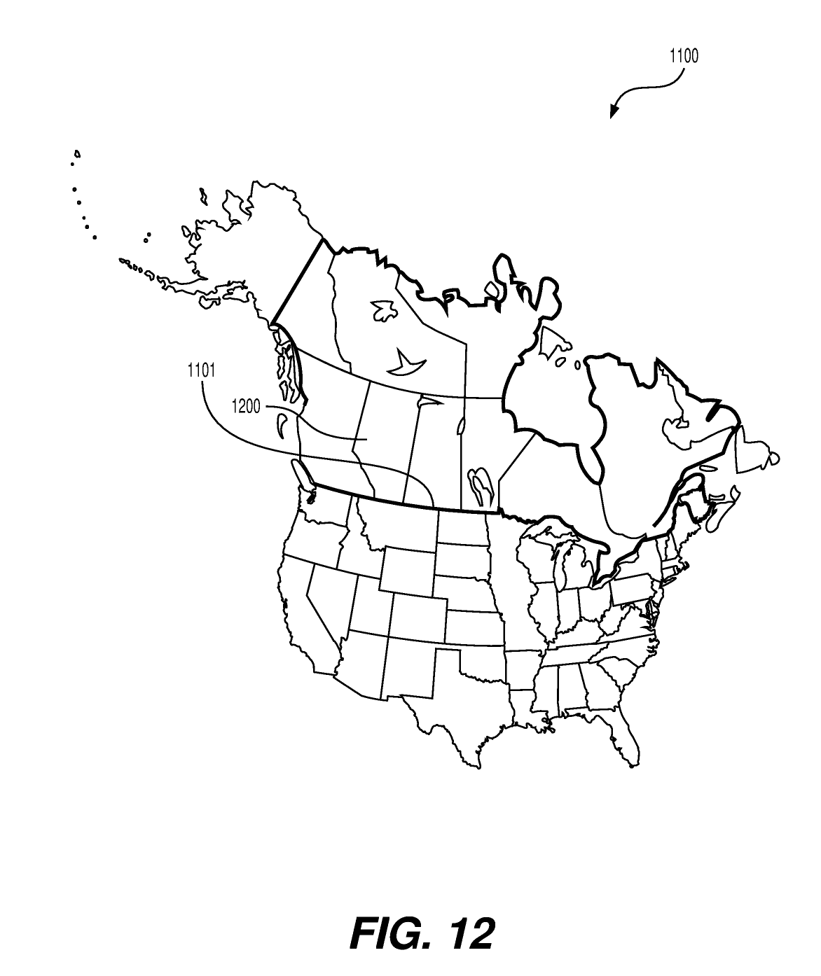

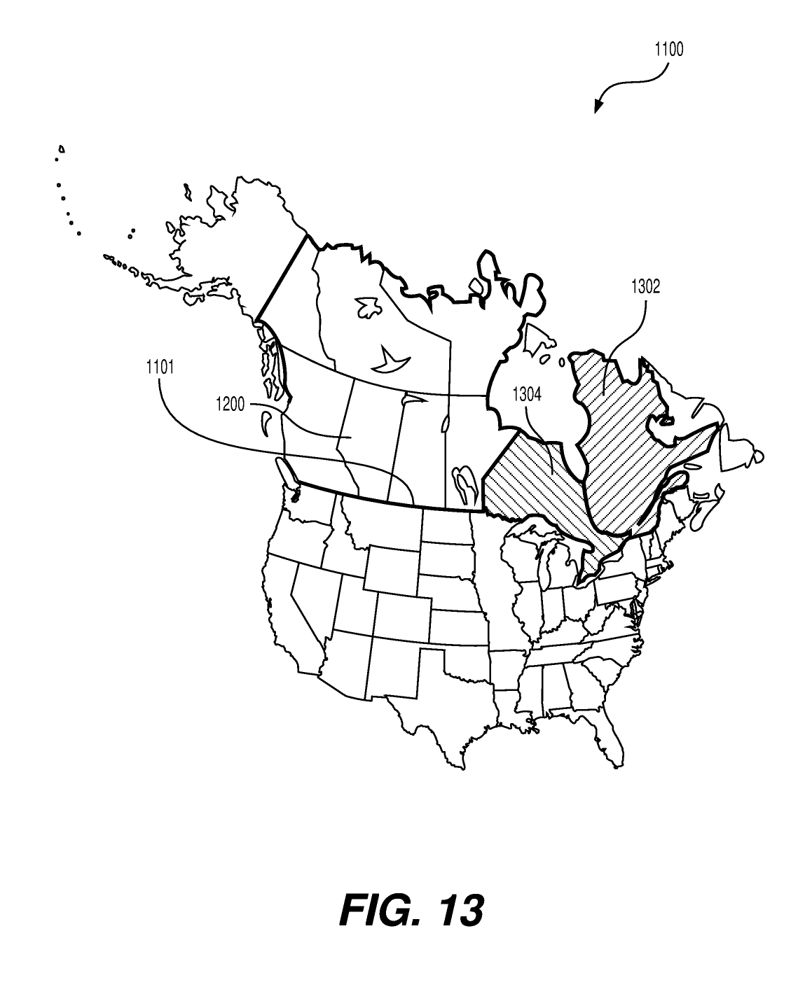

Two-dimensional objects, stored on the information storage medium 104, can have mutual hierarchical relations. As a non-limiting example, as it is depicted in FIG. 11, FIG. 12, and FIG. 13, a first two-dimensional object can be the North America 1101 on a map 1100 of the North America (Mainland), and a second two-dimensional object can be a continental part of Canada 1102 on a map 1100 of North America (Mainland), encompassed by the first two-dimensional object (by the North America 1101). The third and fourth two-dimensional objects 1302, 1304 can be respectively Canadian provinces Quebec 1302 and Ontario 1304, depicted in FIG. 13, both of which are encompassed by the second two-dimensional object 1200 (Canada 1200), and both the third and fourth two-dimensional objects 1302, 1304 (Quebec 1302 and Ontario 1304) being neighbors, located within the second two-dimensional object 1200 (Canada 1200). Two-dimensional objects can have different rank, wherein the rank of a corresponding two-dimensional object is inversely related to a number of two-dimensional objects, encompassing that two-dimensional object. For example, each Quebec 1302 and Ontario 1304, in the example above, are encompassed by two two-dimensional objects (by Canada 1200 and by North America 1101). Canada 1200 is encompassed by one two-dimensional object 1101 (by the North America 1101). North America 1101 is not encompassed on the map 1100 of the North America (Mainland). Therefore, both Quebec 1302 and Ontario 1304 have the lowest rank, Canada 1200 has a medium rank, and the North America 1101 has a highest rank. The same logic is applicable to any other two-dimensional objects. For example, in the picture of a car (not depicted), the car can encompass the image of the door, and the image of the door can encompass images of a door-handle and of a side glass. Therefore, both the door-handle and the side glass have the lowest rank, the door has a medium rank, and the whole car has a highest rank. The door-handle and the side glass are neighbors having the same rank.

Borders of two-dimensional objects, stored on the information storage medium 104, can be defined by perimeters of respective two-dimensional objects. A perimeter of a two-dimensional object can comprise perimeter portions. A perimeter portion can be stored as a line, connecting two extreme points of respective perimeter portion, which extreme points of respective perimeter portion can also be stored on the information storage medium 104. The line can be straight or curved. In respect to a perimeter portion, one of its two extreme points can be stored by the server 102 on the on the information storage medium 104 as a start extreme point, and another one can be stored as an end extreme point.

In some implementations of the present technology, computer-readable instructions, stored on the information storage medium 104, when executed, can cause the processor 108 to acquire two-dimensional objects from the information storage medium 104 (for example, from the database 106), or from an external source (for example, from an external provider of map data).

In some implementations of the present technology, computer-readable instructions, stored on the information storage medium 104, when executed, can cause the processor 108 to convert a two-dimensional object from raster format of representation into a vector format of representation.

In some implementations of the present technology, computer-readable instructions can further cause the processor 108 to store, on the information storage medium 104, the first perimeter by: (i) storing the first perimeter portion as a first line, connecting two extreme points of the first perimeter portion, wherein a first extreme point of the first perimeter portion is stored as a start extreme point of the first perimeter portion, and a second extreme point of the first perimeter portion is stored as an end extreme point the first perimeter portion, and (ii) storing the second perimeter portion of the first perimeter as a second line, connecting two extreme points of the second perimeter portion, wherein a first extreme point of the second perimeter portion is stored as a start extreme point of the second perimeter portion, and a second extreme point of the second perimeter portion is stored as an end extreme point of the second perimeter portion, the end extreme point the first perimeter portion being the start extreme point of the second perimeter portion. Computer-readable instructions can cause the processor 108 to store extreme points of a respective perimeter as connected by respective lines in the same selected rotational direction, starting from an extreme point and finishing by the same extreme point. The selected rotational direction can be either the clockwise direction for all two-dimensional objects, or the counter-clockwise direction for all two-dimensional objects.

In some implementations of the present technology, the first perimeter of the first two-dimensional object can comprise more than two perimeter portions. In that case, more that two perimeter portions can be stored on the information storage medium 104.

For example, referring to FIG. 2, where the first perimeter of the first two-dimensional object 200 is depicted, the first perimeter comprises seven perimeter portions: a first perimeter portion 206 of the first perimeter, being a first line 206; a second perimeter portion 208 of the first perimeter, being a second line 208; an eight perimeter portion 210 of the first perimeter, being an eight line 210; a fourth perimeter portion 212 of the first perimeter, being a fourth line 212; a fifth perimeter portion 214 of the first perimeter, being a fifth line 214; a sixth perimeter portion 202 of the first perimeter, being a sixth line 202; a seventh perimeter portion 204 of the first perimeter, being a seventh line 204. Recalling that, in the text, the words “first”, “second”, “eight”, etc. have been used as adjectives only for the purpose of allowing for distinction between the nouns that they modify from one another, and not for the purpose of describing any particular relationship between those nouns.

The first line 206 connects two extreme points 2042 and 2062 in the clockwise direction 250, so that extreme point 2042 becomes a start extreme point of the first perimeter portion 206, and the extreme point 2062 becomes an end extreme point of the first perimeter portion 206. The second line 208 connects two extreme points 2062 and 2082 also in the clockwise direction 250, so that the extreme point 2062 becomes a start extreme point of the second perimeter portion 208, and the extreme point 2082 becomes the end extreme point of the second perimeter portion 208. Thus, as we can see from this example, extreme point 2062 is at the very same time acts as the end extreme point of the first perimeter portion 206, and the start extreme point of the second perimeter portion 208.

Extreme points of the first perimeter are connected by respective lines in the same selected rotational direction (i.e. the clockwise direction 250, in this example), starting from the extreme point 2042 and finishing by the same extreme point 2042. Extreme point 2042 is the start extreme point of the first perimeter portion 206 of the first perimeter, and extreme point 2042 is also the end extreme point of the seventh perimeter portion 204 of the first perimeter. As it is shown in FIG. 2, all extreme points are connected in the same clockwise direction 250, so that the end extreme point of a respective perimeter portion is the start extreme point of another perimeter portion.

In some implementations of the present technology, computer-readable instructions, stored on the information storage medium 104, when executed, can cause the processor 108 to acquire a second two-dimensional object to be stored on the information storage medium 104, a second perimeter of the second two-dimensional object comprising the second perimeter portion and a third perimeter portion, the second perimeter portion being a first common perimeter portion of the first two-dimensional object and of the second two-dimensional object.

FIG. 3 depicts a non-limiting example of a second two-dimensional object 300. A second perimeter of the second two-dimensional object 300 comprises four perimeter portions: a third perimeter portion 302 of the second perimeter, a second perimeter portion 208 of the second perimeter, a ninth perimeter portion 304 of the second perimeter, and a tenth perimeter portion 306 of the second perimeter. Extreme points of the second perimeter are connected by respective lines in the same selected rotational direction: as it is shown on FIG. 3, all extreme points are connected in the same clockwise direction 250, so that the end extreme point of a respective perimeter portion is the start extreme point of another perimeter portion. As it can be seen from FIG. 3, the second two-dimensional object 300 is encompassed by the first two-dimensional object 200.

FIG. 4 depicts an alternative non-limiting example of the second two-dimensional object 400. A second perimeter of the second two-dimensional object 400 comprises alternative four perimeter portions: a third perimeter portion 402 of the second perimeter, a second perimeter portion 208 of the second perimeter, a ninth perimeter portion 404 of the second perimeter, and a tenth perimeter portion 406 of the second perimeter. Extreme points of this alternative implementation of the second perimeter are also connected by respective lines in the same selected rotational direction: as it is shown on FIG. 4, all extreme points are connected in the same clockwise direction 250, so that the end extreme point of a respective perimeter portion is the start extreme point of another perimeter portion.

Thus, as it is shown on FIG. 2, FIG. 3, and FIG. 4, extreme points of perimeters within each figure can be connected by respective lines in the same (the first) selected rotational direction, namely in the clockwise direction 250, so that the end extreme point of a respective perimeter portion is the start extreme point of another perimeter portion.

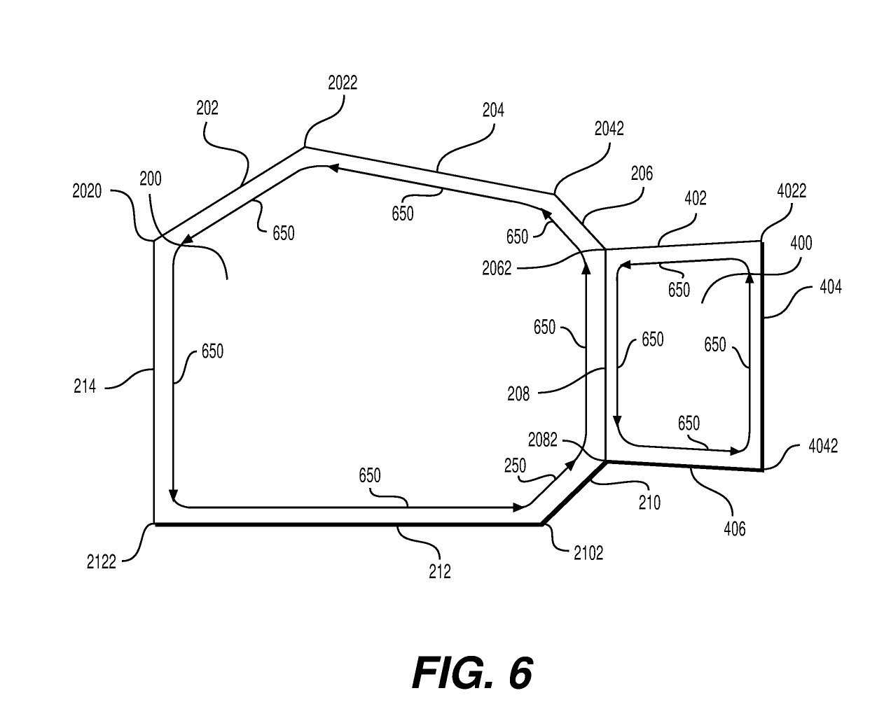

In alternative embodiments, extreme points of perimeters can be connected by respective lines in the same (the second) selected rotational direction, namely in the counter-clockwise direction 650, as it is shown for illustrative purposes on FIG. 6, so that the end extreme point of a respective perimeter portion is the start extreme point of another perimeter portion.

In some implementations of the present technology, computer-readable instructions, stored on the information storage medium 104, when executed, can further cause the processor 108 to verify logical hierarchy of the second two-dimensional object 300 or 400, and the first two-dimensional object 200.

In some implementations of the present technology, computer-readable instructions can further cause the processor 108, responsive to the second two-dimensional object 300 depicted on FIG. 3 being encompassed by the first two-dimensional object 200, to store, on the information storage medium 104, the second perimeter by: (1) storing the third perimeter portion 302 as a third line 302, connecting two extreme points 3020 and 2062 of the third perimeter portion, wherein a first extreme point 3020 of the third perimeter portion is stored as a start extreme point 3020 of the third perimeter portion, and wherein a second extreme point 2062 of the third perimeter portion is stored as an end extreme point 2062 of the third perimeter portion, and (2) storing a reference to the second perimeter portion 208 of the first perimeter.

In some implementations of the present technology, computer-readable instructions can further cause the processor 108, responsive to the first two-dimensional object 200 and the second two-dimensional object 400, depicted on FIG. 4, being neighboring two-dimensional objects 200 and 400, to store, on the information storage medium 104, the second perimeter by: (1) storing the third perimeter portion as a third line 402, connecting two extreme points 2062 and 4022 of the third perimeter portion, wherein the first extreme point 2062 of the third perimeter portion is stored as the start extreme point 2062 of the third perimeter portion, and wherein the second extreme point 4022 of the third perimeter portion is stored as the end extreme point 4022 of the third perimeter portion, and by (2) storing a reference to the second perimeter portion 208 of the first perimeter, the reference including an instruction to interpret the start extreme point 2062 of the second perimeter portion 208 of the first perimeter as the end extreme point 2062 of the second perimeter portion of the second perimeter, and to interpret the end extreme point 2082 of the second perimeter portion 208 of the first perimeter as a start extreme point 2082 of the second perimeter portion 208 of the second perimeter.

In other words, as a result of connection of extreme points in the same rotational direction (in the clockwise direction 250, in this example), the start extreme point of the second perimeter portion 208, in respect to the first two-dimensional object 200, is extreme point 2062, and the end extreme point of the second perimeter portion 208 is extreme point 2082. Therefore, when the first two-dimensional object 200 encompasses the second two-dimensional object 300, as it is shown on FIG. 3, the first common perimeter portion 208 has the same start extreme point 2062 and the same end extreme point 2082 for both the first two-dimensional object 200 and for the second two-dimensional object 300. However, when the first two-dimensional object 200 and the second two-dimensional object 400 are neighboring objects, as it is shown on FIG. 4, they still have the first common perimeter portion 208, but their respective extreme points connected by first common perimeter portion 208 need to be interpreted differently. As it is depicted in FIG. 4, extreme points of both two-dimensional objects 200 and 400 are connected in the clockwise direction 250 (in other words, in the first rotational direction 250), but direction of connection in the first common perimeter portion 208 is different. In respect to the first two-dimensional object 200, the direction of connection is downward, and for the second two-dimensional object 400, the direction of connection is upward. Thus, in respect to the second two-dimensional object 200, extreme point 2062 will be interpreted as the end extreme point 2062, and extreme point 2082 will be interpreted as the start extreme point 2082. Thus, in the case, where two two-dimensional objects 200 and 400 are neighboring objects, the first common perimeter portion 208 of the first two-dimensional object 200 and of the second two-dimensional object is connected in opposing directions of connection.

In some implementations of the present technology, computer-readable instructions can cause the processor 108 to acquire two-dimensional objects. In some implementations of the present technology, computer-readable instructions can cause the processor 108 to acquire two-dimensional objects from the information storage medium 104 and, in some implementations, from the database 106. For example, computer-readable instructions can cause the processor 108 to acquire the first two-dimensional object 200 and the second two-dimensional object 300, depicted on FIG. 3, or to acquire the first two-dimensional object 200 and the second two-dimensional object 400, depicted on FIG. 4.

In some implementations of the present technology, computer-readable instructions can cause the processor 108 to determine if the first two-dimensional object and the second two-dimensional object have a first common perimeter portion. For example, referring to FIG. 3, computer-readable instructions can cause the processor 108 to determine if the first two-dimensional object 200 and the second two-dimensional object 300, depicted on FIG. 3 have a first common perimeter portion 208. As another example, referring to FIG. 4, computer-readable instructions can cause the processor 108 to determine if the first two-dimensional object 200 and the second two-dimensional object 400, depicted on FIG. 4 have a first common perimeter portion 208. As a result, it can be determined that the first two-dimensional object 200 and the second two-dimensional object 300/400 have the first common perimeter portion 208.

It is possible, that two two-dimensional objects not to have a common perimeter portion. For example, if one two-dimensional object is a map Spain (not depicted), and another two-dimensional object is a map Poland (not depicted), they would have no common perimeter portion. As another non-limiting example, if one two-dimensional object, depicted on a picture, is a front wheel of a car, and another two-dimensional object is a rear wheel, they would not have a common perimeter portion either.

In some implementations of the present technology, computer-readable instructions can cause the processor 108, responsive to determining that the first two-dimensional object and the second two-dimensional object do have the first common perimeter portion, to determine if the first common perimeter portion, in respect of both the first two-dimensional object and the second two-dimensional object, are connected in a same direction of connection.

For example, in respect to the two-dimensional objects 200, 300, depicted in FIG. 3, it will be determined that two extreme points 2062 and 2082 of the first common perimeter portion 208, in respect of both the first two-dimensional object 200 and the second two-dimensional object 300, are connected in the same direction of connection “2062-2082”, so that extreme point 2062 is the start extreme point for both the first two-dimensional object 200 and the second two-dimensional object 300, and extreme point 2082 is the end extreme point for both the first two-dimensional object 200 and the second two-dimensional object 300.

In respect to the two-dimensional objects, depicted on FIG. 4, however, it will be determined that two extreme points 2062 and 2082 of the first common perimeter portion 208, in respect to the first two-dimensional object 200 are connected in the direction of connection “2062-2082”, and in respect to the second two-dimensional object 400 they are connected in an opposing direction of connection “2082-2062”. Therefore, extreme point 2062 will be the start extreme point for two-dimensional object 200, and the end extreme point for second two-dimensional object 400. As to extreme point 2082, it will be the end extreme point for two-dimensional object 200, and the start extreme point for second two-dimensional object 400.

In some implementations of the present technology, computer-readable instructions can further cause the processor 108, in response to the sequence of two extreme points of the first common perimeter portion, in respect of both the first two-dimensional object and the second two-dimensional object, being connected in the same direction of connection, (i) to determine sizes of the first two-dimensional object and the second two-dimensional object, and (ii) to determine that a smaller two-dimensional object, selected from: the first two-dimensional object 200 and the second two-dimensional object 300, is encompassed by a larger two-dimensional object, selected from the other one of: the first two-dimensional object 200 and the second two-dimensional object 300. For example, referring to FIG. 3, computer-readable instructions can further cause the processor 108: (i) to determine sizes of the first two-dimensional object 200 and the second two-dimensional object 300, and (ii) based on determination that the second two-dimensional object 300 is smaller than the first two-dimensional object 200, to determine that the second two-dimensional object 300 is encompassed by the first two-dimensional object 200. In other words, the same direction of connection (“2062-2082” and again “2062-2082”) is used as a sign that one of objects encompasses another one. Knowledge of sizes permits determining which one of two two-dimensional objects encompasses the other one.

In some implementations of the present technology, computer-readable instructions can further cause the processor 108, in response to the sequence of two extreme points of the first common perimeter portion, in respect of both the first two-dimensional object and the second two-dimensional object, being connected in opposing directions of connection, determining, that the first two-dimensional object and the second two-dimensional object are neighbors. Such detection would take place, for example, if two two-dimensional objects 200 and 400, depicted on FIG. 4, are being analyzed. As it was described above, directions of connection “2062-2082” and “2082-2062” are opposing directions of connection, which can be used as a sign that two two-dimensional objects 200 and 400 are neighboring objects, and neither of them encompasses another one.

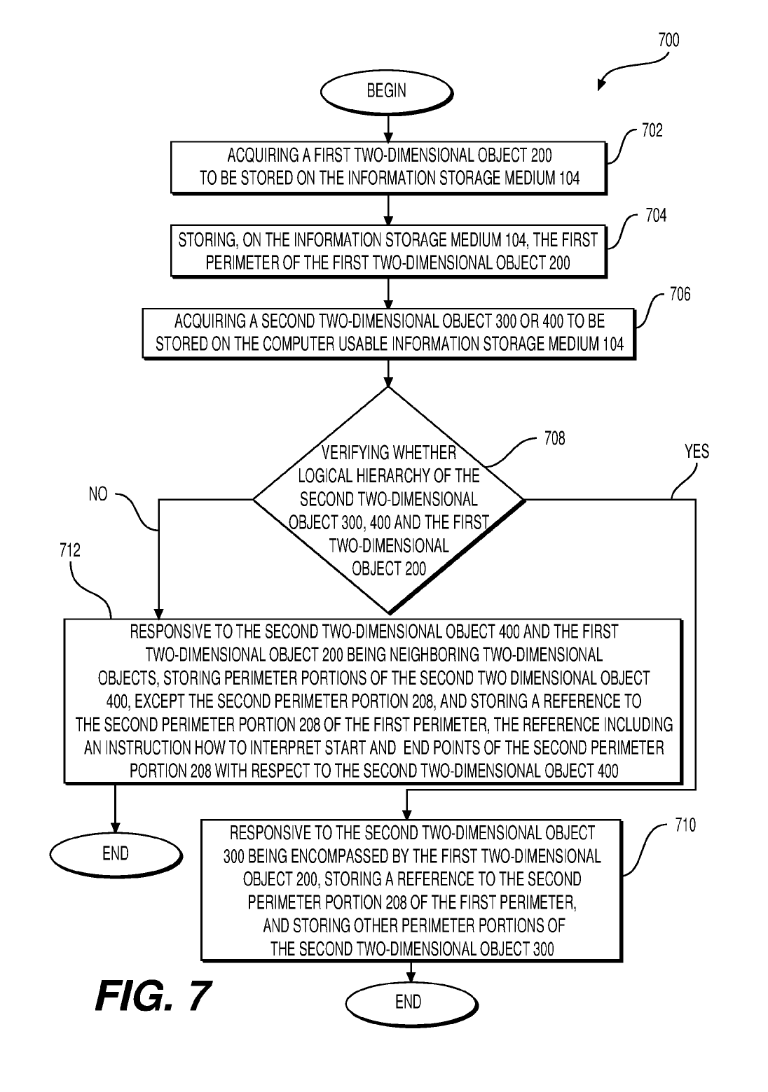

FIG. 7 illustrates a computer-implemented method 700 of storing at least two two-dimensional objects on an information storage medium 104, the method 700 being implemented in accordance with non-limiting embodiments of the present technology and being executable on the server 102 of the system 100 of FIG. 1.

Step 702—Acquiring a First Two-Dimensional Object 200 to be Stored on the Information Storage Medium 104, a First Perimeter of the First Two-Dimensional Object 200 Comprising a First Perimeter Portion 206 and a Second Perimeter Portion 208

The method 700 starts at step 702, where a computing device, being in this implementation of the present technology the server 102, acquires the first two-dimensional object 200 to be stored on the information storage medium 104, the first perimeter of the first two-dimensional object 200 comprising the first perimeter portion 206 and the second perimeter portion 208.

In this implementation of the present technology, the server 102 acquires first two-dimensional object 200 from an external resource, which can be a provider of map data. In other implementations of the present technology, the source of the first two-dimensional picture can be any suitable source, for example, any device that optically scans images and converts them to a digital image. Further, the server 102 can convert a two-dimensional object from raster format of representation into a vector format of representation, and vice versa.

In this implementation of the present technology, the first two-dimensional object 200 is a cadastral plan of a land plot. The first two-dimensional object 200 comprises a polygonal object.

In other embodiments, the first two-dimensional object 200 can be a picture, or any other graphical two-dimensional object.

In other embodiments, the first two-dimensional object 200 also can be a polygonal object, or it can be a two-dimensional object of any shape.

Then, the method 700 proceeds to the step 704.

Step 704—Storing, on the Information Storage Medium 104, the First Perimeter of the First Two-Dimensional Object 200

Next, at step 704, the server 102 stores, on the information storage medium 104, the first perimeter of the first two-dimensional object 200, depicted in any one FIG. 2 or FIG. 3.

In this implementation of the present technology, the server 102 stores the first perimeter in database 106, which database 106 is stored itself on the information storage medium 104 of the server 102.

The server 102 stores the first perimeter by storing perimeter portions of the first perimeter: the first perimeter portion 206 of the first perimeter, being the first line 206, the second perimeter portion 208 of the first perimeter, being the second line 208; the eight perimeter portion 210 of the first perimeter, being the eight line 210; the fourth perimeter portion 212 of the first perimeter, being the fourth line 212; the fifth perimeter portion 214 of the first perimeter, being the fifth line 214; the sixth perimeter portion 202 of the first perimeter, being the sixth line 202; the seventh perimeter portion 204 of the first perimeter, being the seventh line 204.

The server 102 stores these perimeter portion, respectively, as (1) the first line 206 connecting two extreme points 2042 and 2062 in the clockwise direction 250, so that extreme point 2042 becomes the start extreme point of the first perimeter portion 206, and the extreme point 2062 becomes the end extreme point of the first perimeter portion 206; (2) the second line 208 connecting two extreme points 2062 and 2082 also in the clockwise direction 250, so that extreme point 2062 becomes the start extreme point of the second perimeter portion 208, and the extreme point 2082 becomes the end extreme point of the second perimeter portion 208; (3) the eight line 210 connecting two extreme points 2082 and 2102 also in the clockwise direction 250, so that extreme point 2082 becomes the start extreme point of the eight perimeter portion 210, and the extreme point 2102 becomes the end extreme point of the eight perimeter portion 210; (4) the fourth line 212 connecting two extreme points 2102 and 2122 also in the clockwise direction 250, so that extreme point 2102 becomes the start extreme point of the fourth perimeter portion 212, and the extreme point 2122 becomes the end extreme point of the fourth perimeter portion 212; (5) the fifth line 214 connecting two extreme points 2122 and 2020 also in the clockwise direction 250, so that extreme point 2122 becomes the start extreme point of the fifth perimeter portion 214, and the extreme point 2020 becomes the end extreme point of the fifth perimeter portion 214; (6) the sixth line 202 connecting two extreme points 2020 and 2022 also in the clockwise direction 250, so that extreme point 2020 becomes the start extreme point of the sixth perimeter portion 202, and the extreme point 2022 becomes the end extreme point of the sixth perimeter portion 202; (7) the seventh line 204 connecting two extreme points 2022 and 2042 also in the clockwise direction 250, so that extreme point 2022 becomes the start extreme point of the seventh perimeter portion 204, and the extreme point 2042 becomes the end extreme point of the seventh perimeter portion 204. The end extreme point 2042 of the seventh perimeter portion 204 is also the start extreme point 2042 of the first line 206.

Thus, as can be seen from this example, end extreme point of each perimeter portion of a given perimeter is the start extreme point of the next perimeter portion of the same perimeter. All extreme points of a given perimeter are connected by respective lines in the same selected rotational direction 250. Extreme point 2042 is the start extreme point of the first perimeter portion 206 of the first perimeter, and extreme point 2042 is also the end extreme point of the seventh perimeter portion 204 of the first perimeter. Once selected, the same selected rotational direction 250 will be used at step 708 or 712, as applicable.

In alternative embodiments, all extreme points of the first perimeter can be connected by respective lines in the same selected rotational direction 650, being counter-clockwise direction 650. Once selected, the same selected rotational direction 650 will be used for step 708 or 712, as applicable.

Then, the method 700 proceeds to step 706

Step 706—Acquiring a Second Two-Dimensional Object 300 or 400 to be Stored on the Information Storage Medium 104, a Second Perimeter of the Second Two-Dimensional Object 300 or 400 Comprising the Second Perimeter Portion and a Third Perimeter Portion, the Second Perimeter Portion being a First Common Perimeter Portion of the First Two-Dimensional Object and of the Second Two-Dimensional Object

Next, at step 706, the server 102 acquires a second two-dimensional object to be stored on the information storage medium 104.

The second two-dimensional object can be any two-dimensional object having a common perimeter portion with the first two-dimensional object 200. The second two-dimensional object can be the second two-dimensional object 400 being a neighboring object to the first two-dimensional object 200, or it can be a second two-dimensional object 300 being encompassed by the first two-dimensional object 200.

In this implementation of the present technology, the server 102 acquires the second two-dimensional object 300/400 from an external resource, which is provider of map data. In other implementations of the present technology, the source of the second two-dimensional object 300/400 can be any suitable source, for example, any device that optically scans images and converts them to a digital image.

In this implementation of the present technology, the second two-dimensional object 300/400 is a polygonal object which is a land plot plan.

In the case of the second two-dimensional object 300, the second two-dimensional object 300 is a land plot being a part of a larger land plot, the larger land plot being the first two-dimensional object 200. For example, the first two-dimensional object 200 can represent the whole land plot 200, and the second two-dimensional object 300 can represent a part of the land plot 200, where construction of buildings is permitted by cadastral zoning.

In the case of the second two-dimensional object 400, the second two-dimensional object 400 and the first two-dimensional object 200 are neighboring land plots.

In other embodiments, the second two-dimensional object 300/400 can be a picture, or any other graphical two-dimensional object.

In this implementation of the present technology, the second two-dimensional object 300/400 is a polygonal object. In other embodiments, the second two-dimensional object 300/400 also can be a polygonal object, or it can be a two-dimensional object of any shape.

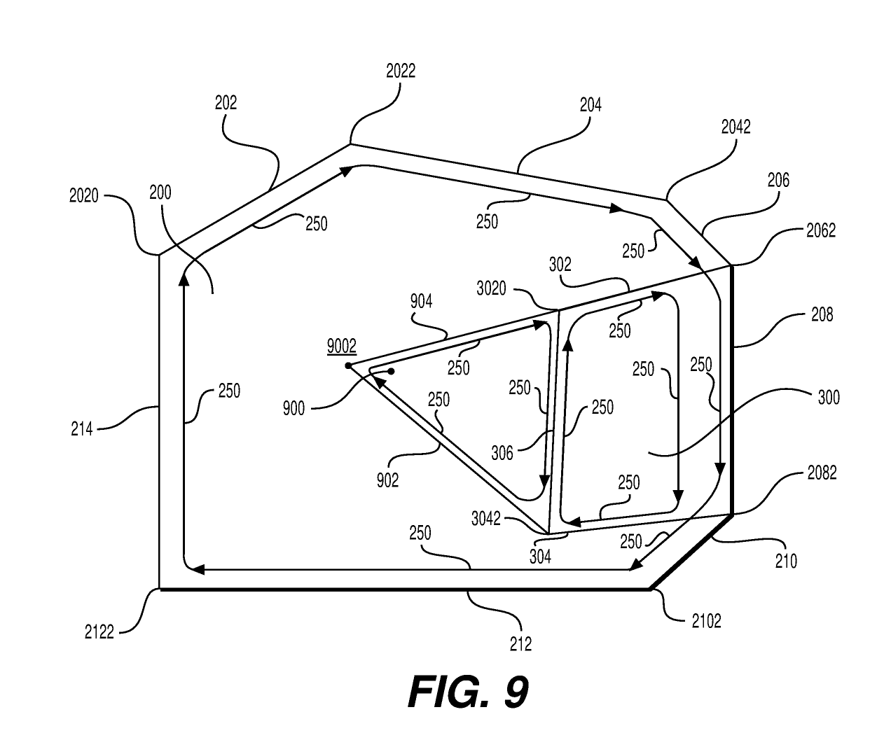

In alternative implementations of the present technology, the server 102 can acquire more than two two-dimensional objects. For example, the server can acquire a third two-dimensional object 900, depicted on FIG. 9.

Then, the method 700 proceeds to the step 708.

Step 708—Verifying Logical Hierarchy of the Second Two-Dimensional Object 300, 400 and the First Two-Dimensional Object 200

Next, at step 708, the server 102 verifies logical hierarchy of the second two-dimensional object 300, 400 and the first two-dimensional object 200.

If, with regard to a second two-dimensional object, the server 102 will determine that the second two-dimensional object is encompassed by the first two-dimensional object 200, then the method 700 proceeds to step 710.

If, with regard to a second two-dimensional object, the server 102 will determine that the second two-dimensional object and the first two-dimensional object 200 are neighboring two-dimensional objects, then the method 700 proceeds to step 712.

For example, with regard to the second two-dimensional object 300, the server 102 will determine that the second two-dimensional object 300 is encompassed by the first two-dimensional object 200, as it is shown on FIG. 3, and the method 700 proceeds to step 710. However, with regard to the second two-dimensional object 400, the server 102 will determine that the second two-dimensional object 400 and the first two-dimensional object 200 are neighboring two-dimensional objects, as it is shown on FIG. 4, and the method 700 proceeds to step 712.

In alternative implementations of the present technology, when server 102 acquires more than two two-dimensional objects, the server 102 can verify logical hierarchy of all these two-dimensional objects, or of at least some of them. For example, when the server 102 acquires a third two-dimensional object 900, depicted in FIG. 9, the server 102 can verify logical hierarchy of the third two-dimensional object 900 vis-a-vis all two-dimensional objects which have common perimeter portions with it. In the implementation, depicted in FIG. 9, the server 102 can verify logical hierarchy of the third two-dimensional object 900 vis-a-vis the second two-dimensional object 300 (both the third two-dimensional object 900 and the second two-dimensional object 300 having a common perimeter portion 306). With regard to the third two-dimensional object 900, the server 102 can determine that the third two-dimensional object 900 and the second two-dimensional object 300 are neighboring two-dimensional objects. The method 700 proceeds then to step 712.

Step 710—Responsive to the Second Two-Dimensional Object 300 being Encompassed by the First Two-Dimensional Object 200, Storing the Second Perimeter as a Reference to the Second Perimeter Portion 208 of the First Perimeter, and Storing Other Perimeter Portions of the Second Two-Dimensional Object 300

As it was mentioned above, method 700 proceeds to step 710 only if a second two-dimensional object is encompassed by the first two-dimensional object 200. This scenario is represented on FIG. 3, where the second two-dimensional object 300 is encompassed by the first two-dimensional object 200.

At step 710, the server 102, responsive to the second two-dimensional object being encompassed by the first two-dimensional object, stores, on the information storage medium 104 in the database 106, a reference to the second perimeter portion 208 of the first perimeter, which second perimeter portion 208 was previously stored as a line connecting the start extreme point 2062 and the end extreme point 2082. Server 102 does not store the second perimeter portion 208 itself, which is already stored during storing of perimeter portions of the first perimeter of the first two-dimensional object 200.

Further, server 102 stores other perimeter portions of the second two-dimensional object 300 which has not been yet stored: the third perimeter portion 302 of the second perimeter, a ninth perimeter portion 304 of the second perimeter, and a tenth perimeter portion 306 of the second perimeter. Extreme points of the second perimeter are connected by respective lines in the same selected rotational direction: as it is shown on FIG. 3, all extreme points are connected in the same clockwise direction 250, so that the end extreme point of a respective perimeter portion is the start extreme point of another perimeter portion.

In this implementation of the present technology, the server 102 stores a reference to the second perimeter portion 208 of the first perimeter, and perimeter portions 302, 304, 306 of the second perimeter, in database 106, which database 106 is stored itself on the information storage medium 104 of the server 102. In other implementations of the present technology, the second perimeter can be stored on the information storage medium 104 in any other convenient way.

The server 102 stores these perimeter portion, respectively, as (1) the third line 302 connecting two extreme points 3020 and 2062 in the clockwise direction 250, so that extreme point 3020 becomes the start extreme point of the third perimeter portion 302 of the second perimeter, and the extreme point 2062 becomes the end extreme point of the third perimeter portion 302 of the second perimeter; (2) the ninth line 304 connecting two extreme points 2082 and 3042 in the clockwise direction 250, so that extreme point 2082 becomes the start extreme point of the ninth perimeter portion 304 of the second perimeter, and the extreme point 3042 becomes the end extreme point of the ninth perimeter portion 304 of the second perimeter; (3) the tenth line 306 connecting two extreme points 3042 and 3020 in the clockwise direction 250, so that extreme point 3042 becomes the start extreme point of the tenth perimeter portion 306 of the second perimeter, and the extreme point 3020 becomes the end extreme point of the tenth perimeter portion 306 of the second perimeter.

Thus, as can be seen from this example, end extreme point of each perimeter portion of a given perimeter is the start extreme point of the next perimeter portion of the same perimeter. All extreme points of a given perimeter are connected by respective lines in the same selected rotational direction 250.

Then, the method 700 ends.

Step 712—Responsive to the Second Two-Dimensional Object 400 and the First Two-Dimensional Object 200 being Neighboring Two-Dimensional Objects, Storing Perimeter Portions of the Second Two-Dimensional Object 400, Except the Second Perimeter Portion 208, and Storing a Reference to the Second Perimeter Portion 208 of the First Perimeter, the Reference Including an Instruction how to Interpret Start and End Points of the Second Perimeter Portion 208 with Respect to the Second Two-Dimensional Object 400

As it was mentioned above, method 700 proceeds to step 712 only if a second two-dimensional object and the first two-dimensional object 200 are neighboring two-dimensional objects. This scenario is represented on FIG. 4, where the second two-dimensional object 400 and the first two-dimensional object 200 are neighboring two-dimensional objects.

At step 712, the server 102, responsive to the second two-dimensional object 400 and the first two-dimensional object 200 being neighboring two-dimensional objects, stores, on the information storage medium 104 in the database 106, a reference to the second perimeter portion 208 of the first perimeter, which second perimeter portion 208 was previously stored as a line connecting the start extreme point 2062 and the end extreme point 2082. The reference to the second perimeter portion 208 of the first perimeter includes an instruction to interpret the start extreme point 2062 of the second perimeter portion 208 of the first perimeter as an end extreme point 2062 of the second perimeter portion 208 of the second perimeter, and to interpret the end extreme point 2082 of the second perimeter portion 208 of the first perimeter as a start extreme point 2082 of the second perimeter portion 208 of the second perimeter. In other words, if the second perimeter portion 208, in respect of the first two-dimensional object 200 is interpreted as a line 208 being “2062-2082”, so the second perimeter portion 208, in respect of the second two-dimensional object 400 is interpreted as a line 208 being “2082-2062”.

Further, server 102 stores other perimeter portions of the second two-dimensional object 400 which has not been yet stored: a third perimeter portion 402 of the second perimeter, a second perimeter portion 208 of the second perimeter, a ninth perimeter portion 404 of the second perimeter, and a tenth perimeter portion 406 of the second perimeter. Extreme points of the second perimeter are connected by respective lines in the same selected rotational direction: as it is shown on FIG. 4, all extreme points are connected in the same clockwise direction 250, so that the end extreme point of a respective perimeter portion is the start extreme point of another perimeter portion.

In this implementation of the present technology, the server 102 stores a reference to the second perimeter portion 208 of the first perimeter, and perimeter portions 402, 404, 406 of the second perimeter, in database 106, which database 106 is stored itself on the information storage medium 104 of the server 102.

The server 102 stores these perimeter portion, respectively, as (1) the third line 402 connecting two extreme points 2062 and 4022 in the clockwise direction 250, so that extreme point 2062 becomes the start extreme point of the third perimeter portion 402 of the second perimeter, and the extreme point 4022 becomes the end extreme point of the third perimeter portion 402 of the second perimeter; (2) the ninth line 404 connecting two extreme points 4022 and 4042 in the clockwise direction 250, so that extreme point 4022 becomes the start extreme point of the ninth perimeter portion 404 of the second perimeter, and the extreme point 4042 becomes the end extreme point of the ninth perimeter portion 404 of the second perimeter; (3) the tenth line 406 connecting two extreme points 4042 and 2082 in the clockwise direction 250, so that extreme point 4042 becomes the start extreme point of the tenth perimeter portion 406 of the second perimeter, and the extreme point 2082 becomes the end extreme point of the tenth perimeter portion 406 of the second perimeter.

Thus, as can be seen from this example, end extreme point of each perimeter portion of a given perimeter is the start extreme point of the next perimeter portion of the same perimeter. All extreme points of a given perimeter are connected by respective lines in the same selected rotational direction 250.

In alternative implementations of the present technology, when server 102 acquires and verifies logical hierarchy of the third two-dimensional object 900, the server 102, responsive to the third two-dimensional object 900 and the second two-dimensional object 300 being neighboring two-dimensional objects, stores, on the information storage medium 104 in the database 106, a reference to the tenth perimeter portion 306 of the second perimeter, which tenth perimeter portion 306 was previously stored as a line connecting the start extreme point 3042 and the end extreme point 3020. The reference to the tenth perimeter portion 306 of the second perimeter includes an instruction to interpret the start extreme point 3042 of the tenth perimeter portion 306 of the second perimeter as an end extreme point 3042 of the tenth perimeter portion 306 of the third perimeter, and to interpret the end extreme point 3020 of the tenth perimeter portion 306 of the second perimeter as a start extreme point 3020 of the tenth perimeter portion 306 of the third perimeter. In other words, if the tenth perimeter portion 306, in respect of the second two-dimensional object 300 is interpreted as a line 306 being “3042-3020”, so the tenth perimeter portion 306, in respect of the third two-dimensional object 900 is interpreted as a line 306 being “3020-3042”.

Further, server 102 stores other perimeter portions of the third two-dimensional object 900 which has not been yet stored: an eleventh perimeter portion 902 of the third perimeter, and a twelfth perimeter portion 904 of the third perimeter. Extreme points of the third perimeter are connected by respective lines in the same selected rotational direction: as it is shown on FIG. 9, all extreme points are connected in the same clockwise direction 250, so that the end extreme point of a respective perimeter portion is the start extreme point of another perimeter portion.

Then, the method 700 ends.

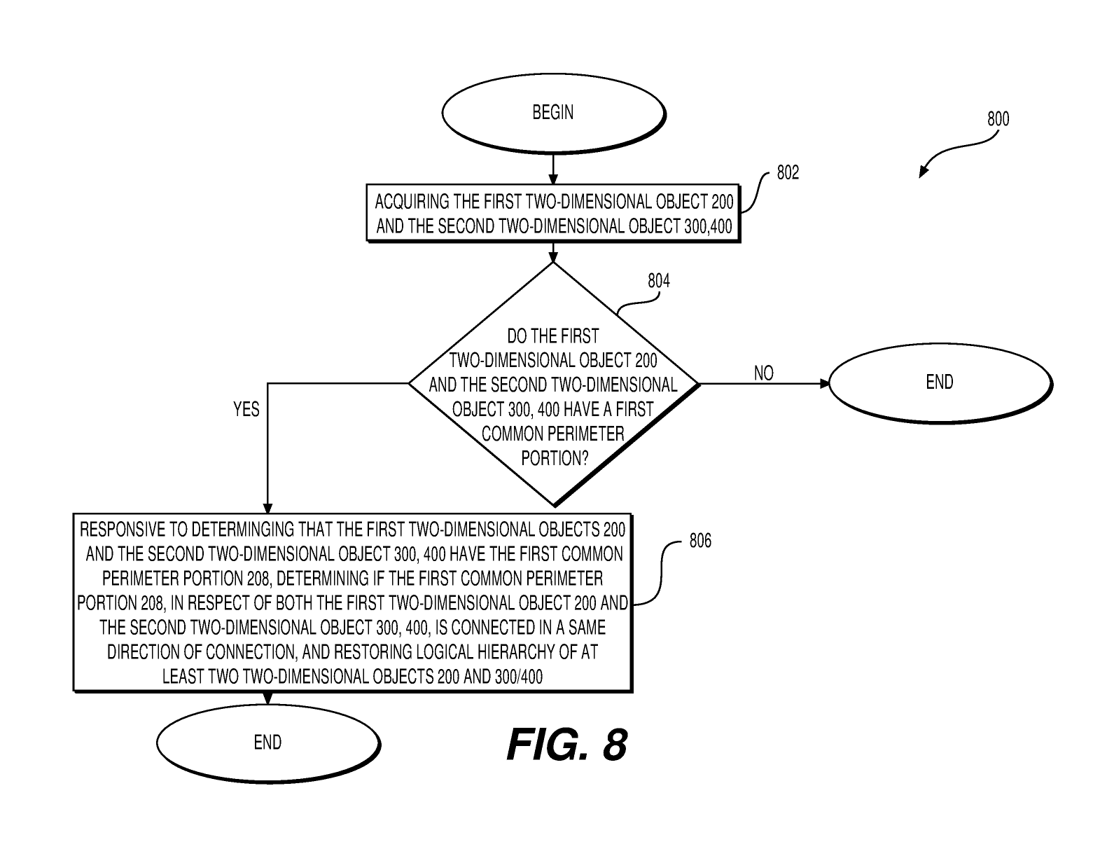

FIG. 8 illustrates a computer-implemented method 800 of restoring of logical hierarchy of at least two two-dimensional objects, a first two-dimensional object 200, depicted on FIG. 2, having a first perimeter, a second two-dimensional object 300/400 (depicted respectively on FIG. 3 and on FIG. 4) having a second perimeter, the first perimeter and the second perimeter comprising perimeter portions, each perimeter portion being a line connecting two extreme points of a respective perimeter portion, extreme points in the first perimeter being connected by respective lines in a first selected rotational direction 250, extreme points of the second perimeter being connected by respective lines in the first selected rotational direction 250. The method 800 is implemented in accordance with non-limiting embodiments of the present technology and is executable on the computing device being, in this implementation, the server 102 of the system 100 of FIG. 1. In describing the method 800, description of the first two-dimensional object 200, description of the second two-dimensional object 300/400, description of respective perimeters, perimeter portions, extreme points, connecting lines, directions of connections will be omitted to avoid redundancy. Corresponding descriptions made above are applicable for the method 800.

Step 802—Acquiring the First Two-Dimensional Object 200 and the Second Two-Dimensional Object 300/400

The method 800 starts at step 802, where the server 102, retrieves the first two-dimensional object 200 and the second two-dimensional object 300/400 from a database 106.

In this implementation of the present technology, the first two-dimensional object 200 and the second two-dimensional object 300/400 were stored on the information storage medium 104 in the database 106. The first two-dimensional object 200 and the second two-dimensional object 300/400 were previously stored on the information storage medium 104 in the database 106 according to the method 700.

In alternative implementation of the present technology, the first two-dimensional object 200 and the second two-dimensional object 300/400 were stored on other information storage medium, to which server 102 has access.

In this implementation of the present technology, the first two-dimensional object 200 and the second two-dimensional object 300/400 are plans of land plots. The first two-dimensional object 200 and the second two-dimensional object 300/400 are a polygonal objects.

In other embodiments, the first two-dimensional object 200 and the second two-dimensional object 300/400 can be a picture, or any other graphical two-dimensional objects.

In other embodiments, the first two-dimensional object 200 and the second two-dimensional object 300/400 also can be a polygonal objects, or they can be two-dimensional objects of any shape.

Then, the method 800 proceeds to the step 804.

Step 804—Determining if the First Two-Dimensional Object 200 and the Second Two-Dimensional Object 300, 400 have a First Common Perimeter Portion

Next, at step 804, the server 102 determines if the first two-dimensional object 200 and the second two-dimensional object 300/400 have a first common perimeter portion.

At this step, the server 102 determines that the database 106 stores the second perimeter portion 208 as one of perimeter portions of a first perimeter of the first two-dimensional object 200. At the same time, the database 106 stores a second perimeter of the second two dimensional object 300/400 as a reference to the second perimeter portion 208 of the first perimeter, and as perimeter portions 302/402, 304/404, 306/406 of the second perimeter. Said reference to the second perimeter portion 208 of the first perimeter can be used by the server 102 as an indicator that the second perimeter portion 208 is the first common perimeter portion 208.

Then, the method 800 proceeds to the step 806.

If there is no common perimeter portion, the method 800 ends.

Step 806—Responsive to Determining that the First Two-Dimensional Object 200 and the Second Two-Dimensional Object 300, 400 have the First Common Perimeter Portion 208, Determining if the First Common Perimeter Portion 208, in Respect of Both the First Two-Dimensional Object 200 and the Second Two-Dimensional Object 300, 400, is Connected in a Same Direction of Connection, and Restoring Logical Hierarchy of at Least Two Two-Dimensional Objects

Next, at step 806, responsive to determining that the first two-dimensional object and the second two-dimensional object have the first common perimeter portion, determining if the first common perimeter portion, in respect of both the first two-dimensional object and the second two-dimensional object, is connected in a same direction of connection.

At this step, the server 102 can retrieve the information about the second perimeter portion 208 of the first perimeter from the database 106. The server will determine that the second perimeter portion 208 of the first perimeter was stored in the database 106 as two extreme points 2062 and 2082 of the second perimeter portion 208 of the first perimeter in the first rotational direction 250, and two extreme points 2062 and 2082 are connected as a sequence “2062-2082”, so that extreme point 2062 is the start extreme point for the first two-dimensional object 200, and extreme point 2082 is the end extreme point for the first two-dimensional object 200.

Further, the server 102 can retrieve the information about how the second perimeter was stored in the database 106.

In respect to the second two-dimensional object 300/400, the server 102 will retrieve information that the second two-dimensional object 300/400 was stored as a reference to the second perimeter portion 208 of the first perimeter, and as perimeter portions 302/402, 304/404, 306/406 of the second perimeter.

The reference to the second perimeter portion 208, in respect to the second two-dimensional object 400, includes an instruction to interpret the start extreme point 2062 of the second perimeter portion 208 of the first perimeter as an end extreme point 2062 of the second perimeter portion 208 of the second perimeter, and to interpret the end extreme point 2082 of the second perimeter portion 208 of the first perimeter as a start extreme point 2082 of the second perimeter portion 208 of the second perimeter. In other words, if the second perimeter portion 208, in respect of the first two-dimensional object 200 is interpreted as a line 208 being “2062-2082”, so the second perimeter portion 208, in respect of the second two-dimensional object 400 is interpreted as a line 208 being “2082-2062”. In response to the sequence of two extreme points of the first common perimeter portion 208, in respect of both the first two-dimensional object 200 and the second two-dimensional object 400, being connected in opposing directions of connection, determining, that the first two-dimensional object 200 and the second two-dimensional object 400 are neighbors.

The reference to the second perimeter portion 208, in respect to the second two-dimensional object 300, however, does not include any instructions how to interpret the start extreme point 2062 of the second perimeter portion 208 of the first perimeter and how to interpret the end extreme point 2082 of the second perimeter portion 208 of the first perimeter. Based on absence of instructions to the contrary, the server 102 determines that the sequence of two extreme points of the first common perimeter portion 208, in respect of both the first two-dimensional object 200 and the second two-dimensional object 300, are connected in the same direction of connection “2082-2062”. In response to the sequence of two extreme points 2082 and 2062 of the first common perimeter portion 208, in respect of both the first two-dimensional object 200 and the second two-dimensional object 300, being connected in the same direction of connection “2082-2062”, the server 102 determining sizes of the first two-dimensional object 200 and the second two-dimensional object 300. The server 102 can determine sizes of the first two-dimensional object 200 and the second two-dimensional object 300 mathematically. Thus, the server 102 can determine, that the first two dimensional object 200 is larger than the second two dimensional object 300. Based on this information, the server 102 determines that the larger two-dimensional object, which is the first two-dimensional object 200, encompasses the smaller two-dimensional object, which is the second two-dimensional object 300.

Then, the server 102 can determine rank of each the first two-dimensional object and the second two-dimensional object, wherein a rank of a corresponding two-dimensional object is inversely related to a number of two-dimensional objects encompassing said one of: the first two-dimensional object and the second two-dimensional object. As it was described above in respect to FIG. 3, the second two dimensional object 300 is encompassed by 1 (one) two-dimensional object (by the first two-dimensional object 200). The first two-dimensional object 200 is not encompassed. Therefore the second two-dimensional object 300 has lower rank than the first two-dimensional object 200. As it was described above in respect to FIG. 4, neither the second two dimensional object 400 nor the first two-dimensional object 200 are not encompassed (zero two-dimensional objects are encompassing the second two dimensional object 400 and the first two-dimensional object 200). Therefore, the second two dimensional object 400 and the first two-dimensional object 200 have the same rank

Then, the method 800 ends.

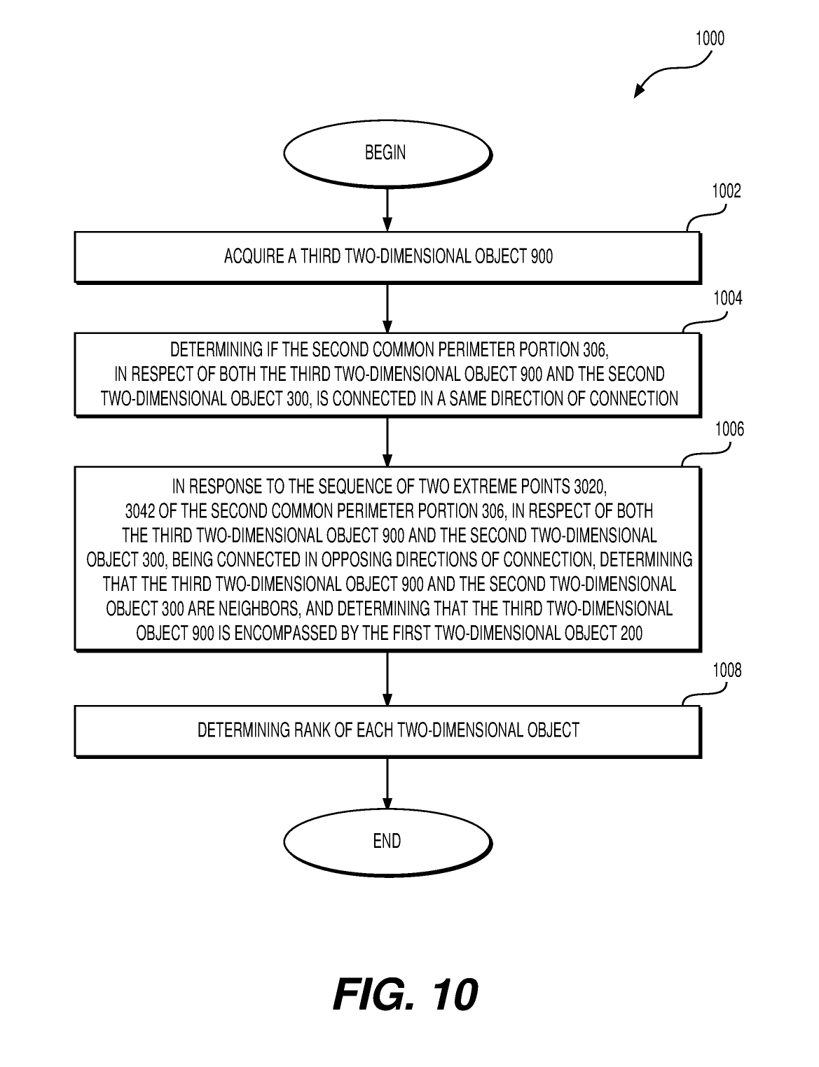

FIG. 10 illustrates a variation 1000 of the computer-implemented method 800, where the second two-dimensional object 300 is encompassed by the first two-dimensional object 200, as it was depicted on FIG. 3, and where the method 800 further comprises retrieving a third two-dimensional object 900, the third two-dimensional object 900 having a second common perimeter portion 306 with the second two-dimensional object 300, the third two-dimensional object 900 having no common perimeter portion with the first two-dimensional object 200, as it is depicted on FIG. 9.

Step 1002—Retrieving the Third Two-Dimensional Object 900

The variation of the method 800 starts at step 1002, where the server 102 further retrieves the third two-dimensional object 900 from a database 106.

In this implementation of the present technology, the server 102 retrieves the third two-dimensional object 900 using substantially same procedure as it was described in step 802 of the method 800.

Then, the variation 1000 of the method 800 proceeds to the step 1004.

Step 1004—Determining if the Second Common Perimeter Portion 306, in Respect of Both the Third Two-Dimensional Object 900 and the Second Two-Dimensional Object 300, is Connected in a Same Direction of Connection

At step 1004, the server 102 determines if the second common perimeter portion 306, in respect of both the third two-dimensional object 900 and the second two-dimensional object 300, is connected in a same direction of connection. This step is substantially similar to the step 806 of the method 800. The server 102 determines, with regard to the second two-dimensional object 300 and the third two-dimensional object 900, that the second common perimeter portion 306, in respect of the third two-dimensional object 900 and the second two-dimensional object 300, is connected in opposing directions of connection (“3042-3020” for the second two-dimensional object 300, and “3020-3042” for the third two-dimensional object 900).

Then, the variation 1000 of the method 800 proceeds to the step 1006.

Step 1006—in Response to the Sequence of Two Extreme Points 3020, 3042 of the Second Common Perimeter Portion 306, in Respect of Both the Third Two-Dimensional Object 900 and the Second Two-Dimensional Object 300, being Connected in Opposing Directions of Connection, Determining that the Third Two-Dimensional Object 900 and the Second Two-Dimensional Object 300 are Neighbors, and Determining that the Third Two-Dimensional Object 900 is Encompassed by the First Two-Dimensional Object 200

At step 1006, the server 102 can retrieve the information about how the third perimeter was stored in the database 106.

In respect to the third two-dimensional object 900, the server 102 retrieves information that the third two-dimensional object 900 was stored as a reference to the tenth perimeter portion 306 of the second perimeter, and as perimeter portions 902, 904 of the third perimeter.

The reference to the tenth perimeter portion 306, in respect to the third two-dimensional object 900, includes an instruction to interpret the start extreme point 3042 of the tenth perimeter portion 306 of the second perimeter as an end extreme point 3042 of the tenth perimeter portion 306 of the third perimeter, and to interpret the end extreme point 3020 of the tenth perimeter portion 306 of the second perimeter as a start extreme point 3020 of the tenth perimeter portion 306 of the third perimeter. In response to the sequence of two extreme points of the second common perimeter portion 306, in respect of both the third two-dimensional object 900 and the second two-dimensional object 300, being connected in different directions of connection, the server 102 determines that the third two-dimensional object 900 and the second two-dimensional object 300 are neighbors.

Based on the established facts that (1) the second two-dimensional object 300 is encompassed by the first two-dimensional object 200, and (2) the second two-dimensional object 300 and the third two-dimensional object 900 are neighboring objects, the server 102 determines that the third two-dimensional object 900 is also encompassed by the first two-dimensional object 200.

Then, the variation 1000 of the method 800 proceeds to the step 1008.

Step 1008—Determining Rank of Each Two-Dimensional Object

At step 1010, the server 102 determines rank of each the first two-dimensional object 200, the second two-dimensional object 300, and the third two-dimensional object 900, wherein a rank of a corresponding two-dimensional object is inversely related to a number of two-dimensional objects encompassing said one of: the first two-dimensional object and the second two-dimensional object. As it was described above in respect to FIG. 9, each the second two dimensional object 300 and the third two dimensional object 900 is encompassed by 1 (one) two-dimensional object (by the first two-dimensional object 200). The first two-dimensional object 200 is not encompassed. Therefore the second two-dimensional object 300 and the third two-dimensional object 900 have the same rank which is lower than the rank of the first two-dimensional object 200.

Then, the Variation 1000 of the Method 800 Ends.

Some of these steps and signal sending-receiving are well known in the art and, as such, have been omitted in certain portions of this description for the sake of simplicity. The signals can be sent-received using optical means (such as a fibre-optic connection), electronic means (such as using wired or wireless connection), and mechanical means (such as pressure-based, temperature based or any other suitable physical parameter based).

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

From a certain perspective, embodiments of the present technology can be summarized as follows, structured in numbered clauses:
1. A method (700) of storing at least two two-dimensional objects on an information storage medium (104), the method (700) executed on a computing device, the computing device having access to the information storage medium (104), the method (700) comprising:
   acquiring (702) a first two-dimensional object (200) to be stored on the information storage medium (104), a first perimeter of the first two-dimensional object (200) comprising a first perimeter portion (206) and a second perimeter portion (208);
   storing (704), on the information storage medium (104), the first perimeter as:
      (i) storing the first perimeter portion (206) as a first line (206), connecting two extreme points (2042, 2062) of the first perimeter portion (206), wherein a first extreme point (2042) of the first perimeter portion (206) is stored as a start extreme point (2042) of the first perimeter portion (206), and a second extreme point (2062) of the first perimeter portion (206) is stored as an end extreme point (2062) the first perimeter portion (206),
      (ii) storing the second perimeter portion (208) of the first perimeter as a second line (208), connecting two extreme points (2062, 2082) of the second perimeter portion (208), wherein a first extreme point (2062) of the second perimeter portion (208) is stored as a start extreme point (2062) of the second perimeter portion (208), and a second extreme point (2082) of the second perimeter portion (208) is stored as an end extreme point (2082) of the second perimeter portion (208), the end extreme point (2062) of the first perimeter portion (206) being the start extreme point (2062) of the second perimeter portion (208); and
   acquiring (706) a second two-dimensional object (300, 400) to be stored on the information storage medium (104), a second perimeter of the second two-dimensional object (300, 400) comprising the second perimeter portion (208) and a third perimeter portion (302, 402), the second perimeter portion (208) being a first common perimeter portion (208) of the first two-dimensional object (200) and of the second two-dimensional object (300, 400);
   verifying (708) logical hierarchy of the second two-dimensional object (300, 400) and the first two-dimensional object (200), and
      (i) responsive to the second two-dimensional object (300) being encompassed by the first two-dimensional object (200), storing (710), on the information storage medium (104), the second perimeter as:
         storing the third perimeter portion (302) as a third line (302), connecting two extreme points (3020, 2062) of the third perimeter portion (302), wherein a first extreme point (3020) of the third perimeter portion (302) is stored as a start extreme point (3020) of the third perimeter portion (302), and wherein a second extreme point (2062) of the third perimeter portion (302) is stored as an end extreme point (2062) of the third perimeter portion (302), and storing a reference to the second perimeter portion (208) of the first perimeter;
      (ii) responsive to the second two-dimensional object (400) and the first two-dimensional object (200) being neighboring two-dimensional objects, storing (712), on the information storage medium (104), the second perimeter as:
         storing the third perimeter portion (402) as a third line (402), connecting two extreme points (2062, 4022) of the third perimeter portion (402), wherein a first extreme point (2062) of the third perimeter portion (402) is stored as a start extreme point (2062) of the third perimeter portion (402), and wherein a second extreme point (4022) of the third perimeter portion (402) is stored as an end extreme point (4022) of the third perimeter portion (402), and
         storing a reference to the second perimeter portion (208) of the first perimeter, the reference including an instruction to interpret the start extreme point (2062) of the second perimeter portion (208) of the first perimeter as an end extreme point (2062) of the second perimeter portion (208) of the second perimeter, and to interpret the end extreme point (2082) of the second perimeter portion (208) of the first perimeter as a start extreme point (2082) of the second perimeter portion (208) of the second perimeter.
2. The method (700) of clause 1, wherein
   extreme points of a respective perimeter are connected by respective lines in a first selected rotational direction, starting from an extreme point and finishing by the same extreme point, and wherein
   the first rotational direction is selected from: (a) a clockwise direction (250) and (b) a counter-clockwise direction (650).
3. The method (700) of any one of clauses 1 to 2, wherein at least one of (a) the first two-dimensional object (200) and (b) the second two-dimensional object (300, 400) is a polygonal object.
4. The method (700) of any one of clauses 1 to 3, wherein each of the first two-dimensional object (200) and the second two-dimensional object (300, 400) is a part of a plurality of two-dimensional objects, and wherein the plurality of two two-dimensional objects is a plurality of map objects.
5. The method (700) of any one of clauses 1 to 4, wherein storing, on the information storage medium (104), at least one, selected from: the first perimeter portion (206), the second perimeter portion (208), and the third perimeter portion (302, 402), is storing in an at least one database (106).
6. The method (700) of any one of clauses 1 to 5, wherein acquiring at least one selected from: the first two-dimensional object (200) and the second two-dimensional object (300, 400) is converting the corresponding at least one selected from: first two-dimensional object (200) and the second two-dimensional object (300, 400) from raster format of representation into a vector format of representation.
7. A server (102) comprising:
   an information storage medium (104);
   a processor (108) operationally connected to the information storage medium (104), the processor (108) configured to store objects, on the information storage medium (104), the processor (108) being further configured to:
      acquire a first two-dimensional object (200) to be stored on the information storage medium (104), a first perimeter of the first two-dimensional object (200) comprising a first perimeter portion (206) and a second perimeter portion (208);
      store, on the information storage medium (104), the first perimeter by:
         (i) storing the first perimeter portion (206) as a first line (206), connecting two extreme points (2042, 2062) of the first perimeter portion (206), wherein a first extreme point (2042) of the first perimeter portion (206) is stored as a start extreme point (2042) of the first perimeter portion (206), and a second extreme point (2062) of the first perimeter portion (206) is stored as an end extreme point (2062) the first perimeter portion (206),
         (ii) storing the second perimeter portion (208) of the first perimeter as a second line (208), connecting two extreme points (2062, 2082) of the second perimeter portion (208), wherein a first extreme point (2062) of the second perimeter portion (208) is stored as a start extreme point (2062) of the second perimeter portion (208), and a second extreme point (2082) of the second perimeter portion (208) is stored as an end extreme point (2082) of the second perimeter portion (208), the end extreme point (2062) of the first perimeter portion (206) being the start extreme point (2062) of the second perimeter portion (208); and
      acquire a second two-dimensional object (300, 400) to be stored on the information storage medium (104), a second perimeter of the second two-dimensional object (300, 400) comprising the second perimeter portion (208) and a third perimeter portion (302, 402), the second perimeter portion (208) being a first common perimeter portion (208) of the first two-dimensional object (200) and of the second two-dimensional object (300, 400);
      verify logical hierarchy of the second two-dimensional object (300, 400) and the first two-dimensional object (200), and
         (i) responsive to the second two-dimensional object (300) being encompassed by the first two-dimensional object (200), store, on the information storage medium (104), the second perimeter by:
            storing the third perimeter portion (302) as a third line (302), connecting two extreme points of the third perimeter portion (302), wherein a first extreme point of the third perimeter portion (302) is stored as a start extreme point of the third perimeter portion (302), and wherein a second extreme point of the third perimeter portion (302) is stored as an end extreme point of the third perimeter portion (302), and storing a reference to the second perimeter portion (208) of the first perimeter;
         (ii) responsive to the second two-dimensional object (400) and the first two-dimensional object (200) being neighboring two-dimensional objects, store, on the information storage medium (104), the second perimeter by:
            storing the third perimeter portion (402) as a third line (402), connecting two extreme points (2062, 4022) of the third perimeter portion (402), wherein a first extreme point (2062) of the third perimeter portion (402) is stored as a start extreme point (2062) of the third perimeter portion (402), and wherein a second extreme point (4022) of the third perimeter portion (402) is stored as an end extreme point (4022) of the third perimeter portion (402), and by
            storing a reference to the second perimeter portion (208) of the first perimeter, the reference including an instruction to interpret the start extreme point (2062) of the second perimeter portion (208) of the first perimeter as an end extreme point (2062) of the second perimeter portion (208) of the second perimeter, and to interpret the end extreme point (2082) of the second perimeter portion (208) of the first perimeter as a start extreme point (2082) of the second perimeter portion (208) of the second perimeter.
8. The server (102) of clause 7, wherein
   extreme points of a respective perimeter are connected by respective lines in a first selected rotational direction, starting from an extreme point and finishing by the same extreme point, and wherein
   the first rotational direction is selected from: (a) a clockwise direction (250) and (b) a counter-clockwise direction (650).
9. The server (102) of any one of clauses 7 to 8, wherein at least one of (a) the first two-dimensional object (200) and (b) the second two-dimensional object (300, 400) is a polygonal object.
10. The server (102) of any one of clauses 7 to 9, wherein each of the first two-dimensional object (200) and the second two-dimensional object (300, 400) is a part of a plurality of two-dimensional objects, and wherein the plurality of two two-dimensional objects is a plurality of map objects.
11. The server (102) of any one of clauses 7 to 10, wherein storing, on the information storage medium (104), at least one, selected from: the first perimeter portion (206), the second perimeter portion (208), and the third perimeter portion (302, 402), is storing in an at least one database (106).
12. The server (102) of any one of clauses 7 to 11, wherein acquiring at least one selected from: the first two-dimensional object (200) and the second two-dimensional object (300, 400) is converting the corresponding at least one selected from: first two-dimensional object (200) and the second two-dimensional object (300, 400) from raster format of representation into a vector format of representation.

From another certain perspective, embodiments of the present technology can be summarized as follows, structured in numbered clauses:
1. A method (800, 1000) of restoring of logical hierarchy of at least two two-dimensional objects (200, 300, 400), a first two-dimensional object (200) having a first perimeter, a second two-dimensional object (300, 400) having a second perimeter, the first perimeter and the second perimeter comprising perimeter portions, each perimeter portion being a line connecting two extreme points of a respective perimeter portion, extreme points in the first perimeter being connected by respective lines in a first selected rotational direction, extreme points of the second perimeter being connected by respective lines in the first selected rotational direction, the method (800, 1000) executed on a computing device, the method (800, 1000) comprising:
   retrieving the first two-dimensional object (200) and the second two-dimensional object (300, 400);
   determining if the first two-dimensional object (200) and the second two-dimensional object (300, 400) have a first common perimeter portion;
   responsive to determining that the first two-dimensional object (200) and the second two-dimensional object (300, 400) having the first common perimeter portion (208), determining if the first common perimeter portion (208), in respect of both the first two-dimensional object (200) and the second two-dimensional object (300/400), is connected in a same direction of connection;
   in response to the sequence of two extreme points (2062, 2082) of the first common perimeter portion (208), in respect of both the first two-dimensional object (200) and the second two-dimensional object (300), being connected in the same direction of connection (2062-2082 and 2062-2082),
      (i) determining sizes of the first two-dimensional object (200) and the second two-dimensional object (300), and
      (ii) determining that a smaller two-dimensional object, selected from: the first two-dimensional object (200) and the second two-dimensional object (300), is encompassed by a larger two-dimensional object, selected from other one of: the first two-dimensional object (200) and the second two-dimensional object (300); and
   in response to the sequence of two extreme points (2062, 2082) of the first common perimeter portion (208), in respect of both the first two-dimensional object (200) and the second two-dimensional object (400), being connected in opposing directions of connection (2062-2082 and 2082-2062), determining, that the first two-dimensional object (200) and the second two-dimensional object (400) are neighbors.
2. The method (800, 1000) of clause 1, wherein the second two-dimensional object (300) is encompassed by the first two-dimensional object (200), the method (800, 1000) further comprising retrieving a third two-dimensional object (900), the third two-dimensional object (900) having a second common perimeter portion (306) with the second two-dimensional object (300), the third two-dimensional object (900) having no common perimeter portion with the first two-dimensional object (200), the method (800, 1000) further comprising:
   determining if the second common perimeter portion (306), in respect of both the third two-dimensional object (900) and the second two-dimensional object (300), is connected in a same direction of connection, and
   in response to the sequence of two extreme points (3020, 3042) of the second common perimeter portion (306), in respect of both the third two-dimensional object (900) and the second two-dimensional object (300), being connected in opposing directions (3020-3042 and 3042-3020) of connection:
      determining that the third two-dimensional object (900) and the second two-dimensional object (300) are neighbors, and
      determining that the third two-dimensional object (900) is encompassed by the first two-dimensional object (200).
3. The method (800, 1000) of any one of clauses 1 to 2, wherein the first two-dimensional object (200) and the second two-dimensional object (300, 400) are a part of a plurality of two-dimensional objects, the method (800, 1000) further comprising determining logical hierarchy of at least two two-dimensional objects from the plurality of two-dimensional objects, wherein a rank of a corresponding two-dimensional object is inversely related to a number of other two-dimensional objects encompassing said corresponding two-dimensional object.
4. The method (800, 1000) of any one of clauses 1 to 3, wherein rotational direction is selected from: (a) a clockwise direction (250) and (b) a counter clockwise direction (650).
5. The method (800, 1000) of any one of clauses 1 to 4, wherein at least one of (a) the first two-dimensional object (200) and (b) the second two-dimensional object (300, 400) is a polygonal object.
6. The method (800, 1000) of any one of clauses 1 to 5, wherein the first two-dimensional object (200) and the second two-dimensional object (300, 400) are the part of a plurality of two-dimensional objects, and wherein the plurality of two two-dimensional objects is a plurality of map objects.
7. The method (800, 1000) of any one of clauses 1 to 6, prior to the retrieving the first perimeter, the second perimeter, and determining if the first two-dimensional object (200) and the second two-dimensional object (300, 400) have the first common perimeter portion (208), the method (800, 1000) further comprising:
   acquiring (702) the first two-dimensional object (200) to be stored on the information storage medium (104), the first perimeter of the first two-dimensional object (200) comprising a first perimeter portion (206) and a second perimeter portion (208);
   storing (704), on the information storage medium (104), the first perimeter as:
      (i) storing the first perimeter portion (206) as a first line (206), connecting two extreme points (2042, 2062) of the first perimeter portion (206), wherein a first extreme point (2042) of the first perimeter portion (206) is stored as a start extreme point (2042) of the first perimeter portion (206), and a second extreme point (2062) of the first perimeter portion (206) is stored as an end extreme point (2062) the first perimeter portion (206),
      (ii) storing the second perimeter portion (208) of the first perimeter as a second line (208), connecting two extreme points (2062, 2082) of the second perimeter portion (208), wherein a first extreme point (2062) of the second perimeter portion (208) is stored as a start extreme point (2062) of the second perimeter portion (208), and a second extreme point (2082) of the second perimeter portion (208) is stored as an end extreme point (2082) of the second perimeter portion (208), the end extreme point (2062) of the first perimeter portion (206) being the start extreme point (2062) of the second perimeter portion (208); and
   acquiring (706) the second two-dimensional object (300, 400) to be stored on the information storage medium (104), the second perimeter of the second two-dimensional object (300, 400) comprising the second perimeter portion (208) and a third perimeter portion (302, 402), the second perimeter portion (208) being the first common perimeter portion (208) of the first two-dimensional object (200) and of the second two-dimensional object (300, 400);
   verifying (708) logical hierarchy of the second two-dimensional object (300, 400) and the first two-dimensional object (200), and
      (i) responsive to the second two-dimensional object (300) being encompassed by the first two-dimensional object (200), storing (710), on the information storage medium (104), the second perimeter as:
         storing the third perimeter portion (302) as a third line (302), connecting two extreme points (3020, 2062) of the third perimeter portion (302), wherein a first extreme point (3020) of the third perimeter portion (302) is stored as a start extreme point (3020) of the third perimeter portion (302), and wherein a second extreme point (2062) of the third perimeter portion (302) is stored as an end extreme point (2062) of the third perimeter portion (302), and
         storing a reference to the second perimeter portion (208) of the first perimeter;
      (ii) responsive to the second two-dimensional object (400) and the first two-dimensional object (200) being neighboring two-dimensional objects, storing (712), on the information storage medium (104), the second perimeter as:
         storing the third perimeter portion (402) as a third line (402), connecting two extreme points (2062, 4022) of the third perimeter portion (402), wherein a first extreme point (2062) of the third perimeter portion (402) is stored as a start extreme point (2062) of the third perimeter portion (402), and wherein a second extreme point (4022) of the third perimeter portion (402) is stored as an end extreme point (4022) of the third perimeter portion (402), and
         storing a reference to the second perimeter portion (208) of the first perimeter, the reference including an instruction to interpret the start extreme point (2062) of the second perimeter portion (208) of the first perimeter as an end extreme point (2062) of the second perimeter portion (208) of the second perimeter, and to interpret the end extreme point (2082) of the second perimeter portion (208) of the first perimeter as a start extreme point (2082) of the second perimeter portion (208) of the second perimeter.
8. A server (102) comprising:
   an information storage medium (104);
   a processor (108) operationally connected to the information storage medium (104), the processor (108) configured to store objects, on the information storage medium (104), the processor (108) being further configured to:
      retrieve the first two-dimensional object (200) and the second two-dimensional object (300, 400);
      determine if the first two-dimensional object (200) and the second two-dimensional object (300, 400) have a first common perimeter portion (208);
      responsive to determining that the first two-dimensional object (200) and the second two-dimensional object (300, 400) having the first common perimeter portion (208), determine if the first common perimeter portion (208), in respect of both the first two-dimensional object (200) and the second two-dimensional object (300, 400), is connected in a same direction of connection;
      in response to the sequence of two extreme points of the first common perimeter portion (208), in respect of both the first two-dimensional object (200) and the second two-dimensional object (300), being connected in the same direction of connection (2062-2082 and 2062-2082),
         (i) determine sizes of the first two-dimensional object (200) and the second two-dimensional object (300), and
         (ii) determine that a smaller two-dimensional object, selected from: the first two-dimensional object (200) and the second two-dimensional object (300), is encompassed by a larger two-dimensional object, selected from other one of: the first two-dimensional object (200) and the second two-dimensional object (300); and
      in response to the sequence of two extreme points (2062, 2082) of the first common perimeter portion (208), in respect of both the first two-dimensional object (200) and the second two-dimensional object (400), being connected in opposing directions of connection (2062-2082 and 2082-2062), determining, that the first two-dimensional object (200) and the second two-dimensional object (400) are neighbors.
9. The server (102) of clause 8, wherein the second two-dimensional object (300) is encompassed by the first two-dimensional object (200), the processor (108) being further configured to retrieve a third two-dimensional object (900), the third two-dimensional object (900) having a second common perimeter portion (306) with the second two-dimensional object (300), the third two-dimensional object (900) having no common perimeter portion with the first two-dimensional object (200), the processor (108) being further configured to:
   determine if the second common perimeter portion (306), in respect of both the third two-dimensional object (900) and the second two-dimensional object (300), is connected in a same direction of connection, and
   in response to the sequence of two extreme points (3020, 3042) of the second common perimeter portion (306), in respect of both the third two-dimensional object (900) and the second two-dimensional object (300), being connected in opposing directions of connection:
      determine that the third two-dimensional object (900) and the second two-dimensional object (300) are neighbors, and
      determine that the third two-dimensional object (900) is encompassed by the first two-dimensional object (200).
10. The server (102) of any one of clauses 8 to 9, the processor (108) being further configured to determine logical hierarchy of at least two two-dimensional objects, being a part of a plurality of two-dimensional objects, wherein a rank of a corresponding two-dimensional object is inversely related to a number of other two-dimensional objects encompassing said corresponding two-dimensional object.
11. The server (102) of any one of clauses 8 to 10, wherein rotational direction is selected from:
   (a) a clockwise direction (250) and (b) a counter clockwise direction (650).
12. The server (102) of any one of clauses 8 to 11, wherein at least one of (a) the first two-dimensional object (200) and (b) the second two-dimensional object (300, 400) is a polygonal object.
13. The server (102) of any one of clauses 8 to 12, wherein the first two-dimensional object (200) and the second two-dimensional object (300, 400) are a part of a plurality of two-dimensional objects, and wherein the plurality of two two-dimensional objects is a plurality of map objects.
14. The server (102) of any one of clauses 8 to 13, the processor (108) being further configured to:
   acquire the first two-dimensional object (200) to be stored on the information storage medium (104), a first perimeter of the first two-dimensional object (200) comprising a first perimeter portion (206) and a second perimeter portion (208);
   store, on the information storage medium (104), the first perimeter by:
      (i) storing the first perimeter portion (206) as a first line (206), connecting two extreme points (2042, 2062) of the first perimeter portion (206), wherein a first extreme point (2042) of the first perimeter portion (206) is stored as a start extreme point (2042) of the first perimeter portion (206), and a second extreme point (2062) of the first perimeter portion (206) is stored as an end extreme point (2062) the first perimeter portion (206),
      (ii) storing the second perimeter portion (208) of the first perimeter as a second line (208), connecting two extreme points (2062, 2082) of the second perimeter portion (208), wherein a first extreme point (2062) of the second perimeter portion (208) is stored as a start extreme point (2062) of the second perimeter portion (208), and a second extreme point (2082) of the second perimeter portion (208) is stored as an end extreme point (2082) of the second perimeter portion (208), the end extreme point (2062) of the first perimeter portion (206) being the start extreme point (2062) of the second perimeter portion (208); and
   acquire the second two-dimensional object (300, 400) to be stored on the information storage medium (104), the second perimeter of the second two-dimensional object (300, 400) comprising the second perimeter portion (208) and a third perimeter portion (302, 402), the second perimeter portion (208) being the first common perimeter portion (208) of the first two-dimensional object (200) and of the second two-dimensional object (300, 400);
   verify logical hierarchy of the second two-dimensional object (300, 400) and the first two-dimensional object (200), and
      (i) responsive to the second two-dimensional object (300) being encompassed by the first two-dimensional object (200), store, on the information storage medium (104), the second perimeter by:
         storing the third perimeter portion (302) as a third line (302), connecting two extreme points (3020, 2062) of the third perimeter portion (302), wherein a first extreme point (3020) of the third perimeter portion (302) is stored as a start extreme point (3020) of the third perimeter portion (302), and wherein a second extreme point (2062) of the third perimeter portion (302) is stored as an end extreme point (2062) of the third perimeter portion (302), and
         storing a reference to the second perimeter portion (208) of the first perimeter;
      (ii) responsive to the second two-dimensional object (400) and the first two-dimensional object (200) being neighboring two-dimensional objects, store, on the information storage medium (104), the second perimeter by:
         storing the third perimeter portion (402) as a third line (402), connecting two extreme points (2062, 4022) of the third perimeter portion (402), wherein a first extreme point (2062) of the third perimeter portion (402) is stored as a start extreme point (2062) of the third perimeter portion (402), and wherein a second extreme point (4022) of the third perimeter portion (402) is stored as an end extreme point (4022) of the third perimeter portion (402), and storing a reference to the second perimeter portion (208) of the first perimeter, the reference including an instruction to interpret the start extreme point (2062) of the second perimeter portion (208) of the first perimeter as an end extreme point (2062) of the second perimeter portion (208) of the second perimeter, and to interpret the end extreme point (2082) of the second perimeter portion (208) of the first perimeter as a start extreme point (2082) of the second perimeter portion (208) of the second perimeter.

What is claimed is:

1. A method of storing at least two two-dimensional objects on an information storage medium, the method executed on a computing device, the computing device having access to the information storage medium, the method comprising:
acquiring a first two-dimensional object to be stored on the information storage medium, a first perimeter of the first two-dimensional object comprising a first perimeter portion and a second perimeter portion;
storing, on the information storage medium, the first perimeter as:
(i) storing the first perimeter portion as a first line, connecting two extreme points of the first perimeter portion, wherein a first extreme point of the first perimeter portion is stored as a start extreme point of the first perimeter portion, and a second extreme point of the first perimeter portion is stored as an end extreme point the first perimeter portion,
(ii) storing the second perimeter portion of the first perimeter as a second line, connecting two extreme points of the second perimeter portion, wherein a first extreme point of the second perimeter portion is stored as a start extreme point of the second perimeter portion, and a second extreme point of the second perimeter portion is stored as an end extreme point of the second perimeter portion, the end extreme point the first perimeter portion being the start extreme point of the second perimeter portion; and
acquiring a second two-dimensional object to be stored on the information storage medium, a second perimeter of the second two-dimensional object comprising the second perimeter portion and a third perimeter portion, the second perimeter portion being a first common perimeter portion of the first two-dimensional object and of the second two-dimensional object;
verifying logical hierarchy of the second two-dimensional object and the first two-dimensional object, and
(i) responsive to the second two-dimensional object being encompassed by the first two-dimensional object, storing, on the information storage medium, the second perimeter as:
storing the third perimeter portion as a third line, connecting two extreme points of the third perimeter portion, wherein a first extreme point of the third perimeter portion is stored as a start extreme point of the third perimeter portion, and wherein a second extreme point of the third perimeter portion is stored as an end extreme point of the third perimeter portion, and
storing a reference to the second perimeter portion of the first perimeter;
(ii) responsive to the second two-dimensional object and the first two-dimensional object being neighboring two-dimensional objects, storing, on the information storage medium, the second perimeter as:
storing the third perimeter portion as a third line, connecting two extreme points of the third perimeter portion, wherein a first extreme point of the third perimeter portion is stored as a start extreme point of the third perimeter portion, and wherein a second extreme point of the third perimeter portion is stored as an end extreme point of the third perimeter portion, and
storing a reference to the second perimeter portion of the first perimeter, the reference including an instruction to interpret the start extreme point of the second perimeter portion of the first perimeter as an end extreme point of the second perimeter portion of the second perimeter, and to interpret the end extreme point of the second perimeter portion of the first perimeter as a start extreme point of the second perimeter portion of the second perimeter.

2. The method of claim 1, wherein
extreme points of a respective perimeter are connected by respective lines in a first selected rotational direction, starting from an extreme point and finishing by the same extreme point, and wherein
the first rotational direction is selected from: (a) a clockwise direction and (b) a counter-clockwise direction.

3. The method of claim 1, wherein at least one of (a) the first two-dimensional object and (b) the second two-dimensional object is a polygonal object.

4. The method of claim 1, wherein each of the first two-dimensional object and the second two-dimensional object is a part of a plurality of two-dimensional objects, and wherein the plurality of two two-dimensional objects is a plurality of map objects.

5. The method of claim 1, wherein storing, on the information storage medium, at least one, selected from: the first perimeter portion, the second perimeter portion, and the third perimeter portion, is storing in an at least one database.

6. The method of claim 1, wherein acquiring at least one selected from: the first two-dimensional object and the second two-dimensional object is converting the corresponding at least one selected from: first two-dimensional object and the second two-dimensional object from raster format of representation into a vector format of representation.

7. A server comprising:
an information storage medium;
a processor operationally connected to the information storage medium, the processor configured to store objects, on the information storage medium, the processor being further configured to:
acquire a first two-dimensional object to be stored on the information storage medium, a first perimeter of the first two-dimensional object comprising a first perimeter portion and a second perimeter portion;
store, on the information storage medium, the first perimeter by:
(i) storing the first perimeter portion as a first line, connecting two extreme points of the first perimeter portion, wherein a first extreme point of the first perimeter portion is stored as a start extreme point of the first perimeter portion, and a second extreme point of the first perimeter portion is stored as an end extreme point the first perimeter portion,
(ii) storing the second perimeter portion of the first perimeter as a second line, connecting two extreme points of the second perimeter portion, wherein a first extreme point of the second perimeter portion is stored as a start extreme point of the second perimeter portion, and a second extreme point of the second perimeter portion is stored as an end extreme point of the second perimeter portion, the end extreme point the first perimeter portion being the start extreme point of the second perimeter portion; and
acquire a second two-dimensional object to be stored on the information storage medium, a second perimeter of the second two-dimensional object comprising the second perimeter portion and a third perimeter portion, the second perimeter portion being a first common perimeter portion of the first two-dimensional object and of the second two-dimensional object;
verify logical hierarchy of the second two-dimensional object and the first two-dimensional object, and
(i) responsive to the second two-dimensional object being encompassed by the first two-dimensional object, store, on the information storage medium, the second perimeter by:
storing the third perimeter portion as a third line, connecting two extreme points of the third perimeter portion, wherein a first extreme point of the third perimeter portion is stored as a start extreme point of the third perimeter portion, and wherein a second extreme point of the third perimeter portion is stored as an end extreme point of the third perimeter portion, and
storing a reference to the second perimeter portion of the first perimeter;
(ii) responsive to the second two-dimensional object and the first two-dimensional object being neighboring two-dimensional objects, store, on the information storage medium, the second perimeter by:
storing the third perimeter portion as a third line, connecting two extreme points of the third perimeter portion, wherein a first extreme point of the third perimeter portion is stored as a start extreme point of the third perimeter portion, and wherein a second extreme point of the third perimeter portion is stored as an end extreme point of the third perimeter portion, and by
storing a reference to the second perimeter portion of the first perimeter, the reference including an instruction to interpret the start extreme point of the second perimeter portion of the first perimeter as an end extreme point of the second perimeter portion of the second perimeter, and to interpret the end extreme point of the second perimeter portion of the first perimeter as a start extreme point of the second perimeter portion of the second perimeter.

8. The server of claim 7, wherein
extreme points of a respective perimeter are connected by respective lines in a first selected rotational direction, starting from an extreme point and finishing by the same extreme point, and wherein
the first rotational direction is selected from: (a) a clockwise direction and (b) a counter-clockwise direction.

9. The server of claim 7, wherein at least one of (a) the first two-dimensional object and (b) the second two-dimensional object is a polygonal object.

10. The server of claim 7, wherein each of the first two-dimensional object and the second two-dimensional object is a part of a plurality of two-dimensional objects, and wherein the plurality of two two-dimensional objects is a plurality of map objects.

11. The server of claim 7, wherein storing, on the information storage medium, at least one, selected from: the first perimeter portion, the second perimeter portion, and the third perimeter portion, is storing in an at least one database.

12. The server of claim 7, wherein acquiring at least one selected from: the first two-dimensional object and the second two-dimensional object is converting the corresponding at least one selected from: first two-dimensional object and the second two-dimensional object from raster format of representation into a vector format of representation.
